(19) United States
(12) Patent Application Publication
(10) Pub. No.: US 2013/0212130 A1
(43) Pub. Date: Aug. 15, 2013

(54) Zone Oriented Applications, Systems and Methods

(71) Applicant: Flybits, Inc., (US)

(72) Inventor: Hossein Rahnama, Toronto (CA)

(73) Assignee: FLYBITS, INC., Toronto (CA)

(21) Appl. No.: 13/722,376

(22) Filed: Dec. 20, 2012

Related U.S. Application Data
(60) Provisional application No. 61/599,095, filed on Feb. 15, 2012.

(51) Int. Cl. G06F 17/30

(52) U.S. Cl. CPC G06F 17/30292
USPC 707/792

(57) ABSTRACT

Zone management infrastructure systems and methods are presented. A zone comprises a set of boundary conditions, which can include a geographic boundary. Zones further comprise a zone object representing the nature of the zone and the services or applications offered by the zone. Zone objects have intrinsic value based on their boundary conditions as well as the services they offer. Zone owners can allow third parties to offer services for the zone in exchange for a fee.

This Application claims the benefit of priority to U.S. provisional application having Ser. No. 61/599,095 filed on Feb. 15, 2012. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is zone-based technologies.

### BACKGROUND

With the advent of mobile computing devices users have an ever growing desire to use their mobile devices to interface with the real world or virtual worlds. Information can be provided to the mobile devices on demand. However, current technologies require a user to submit queries for the information, which requires the user to be a priori aware of their needs or to construct a proper query. Unfortunately such approaches can be inefficient or fraught with error. Ideally, users should be able to obtain information or interact with information seamlessly based on the ambient presence of relevant or contextual information.

Some effort has been directed to providing data to users based on information related to a user's devices, location information for example. Example previous efforts include the following:
U.S. Pat. No. 7,248,852 to Cabrera et al. titled “Method and System for Wireless Distribution of Local Information”, filed as an international application on Apr. 29, 2002, indicates that local information can be presented to a user based on their geographical location. If a user leaves an area, local information can be removed from the device.
U.S. Pat. No. 7,317,927 to Staton et al. titled “Method and System to Monitor Persons

Utilizing Wireless Media”, filed Jun. 21, 2005, discusses defining geographic zones using longitude and latitude coordinates. When devices are in the same geographical zone, they can be configured to communication with each other.
U.S. Pat. No. 7,493,211 to Breen titled “System and Method for Updating Geo-Fencing Information on Mobile Devices”, filed Dec. 16, 2005, describes a system for tracking fleets of vehicles through the use of geo-fences and updating geo-fence information on a mobile device.
U.S. Pat. No. 7,534,169 to Amaitis et al. titled “System and Method for Wireless Gaming System with User Profiles”, filed Aug. 9, 2005, discusses using location verification information to determine if a gaming system is in a non-gaming zone.
U.S. Pat. No. 8,000,689 to Featherstone et al. titled “System and Methods for Monitoring the Context Associated with a Mobile Communication Device”, filed Feb. 29, 2008, describes using device context information to determine how to manage incoming or outgoing calls to the device.
U.S. patent application publication 2010/0069035 to Johnson titled “System and Method for Location Based Exchanges of Data Facilitating Distributed Location Applications”, filed Nov. 13, 2009, discusses providing peer-to-peer interactions based on locations.
U.S. patent application publication 2010/0075648 to Matsuoka et al. titled “System and Method of Localize Applications on a Mobile Computing Device”, filed Sep. 24, 2008, describes localizing applications based on geographic location and local time.
U.S. patent application publication 2010/0127919 to Curran et al. titled “Geo-Fence with Minimal False Alarms”, filed Nov. 21, 2008, discussing monitoring when devices enter or leave geographic zones and providing alerts accordingly. False alarms are minimized through comparing a device location against threshold triggers.
U.S. patent application publication 2010/0253508 to Koen et al. titled “Configurable Geofences”, filed Jun. 14, 2010, describes dynamically reconfiguring wireless devices based on event profiles and geofence information.
Co-owned U.S. patent application publication 2011/0125850 to Rahnama et al. titled “Method, Apparatus and System for Social Networking”, filed as an international application on Mar. 11, 2008, describes matching people together based on local proximity.
U.S. patent application publication 2011/0209069 to Mohler titled “Device Skins for User Roles, Context, and Function and Supporting System Mashups”, filed Jul. 16, 2010, describes construction of a mashup of information on a user device based on a context.
U.S. patent application publication 2011/0238647 to Ingram et al. titled “System for Event-Based Intelligent-Targeting”, filed Mar. 23, 2011, describes providing relevant content to a user based on events associated with the user's situation.
U.S. patent application publication 2011/0251990 to Yarvis et al. titled “Techniques for Template-Based Predications and Recommendations”, filed Jun. 20, 2011, discloses using contextual information, possibly from a GPS sensor, about users to predict future user behaviors.
U.S. patent application publication 2011/0256881 to Huang et al. titled “Context-Based Reverse Geocoding”, filed Apr. 20, 2010, references using a device context, possibly including a pattern of movement, to select a relevant geofence.
U.S. patent application 2011/0313874 to Hardie et al. titled “Method and Apparatus for Managing Location-based Transactions”, filed Jun. 22, 2010, discusses transmitting notifications to user's devices based on the locations of the devices.
International patent application WO 2010/009324 to Holeman et al. titled “Method for Dynamic Creation of a Geofence in a Wireless System”, filed Jul. 16, 2009, describes creating a geofence around a user's location without having to look up their present location.

Interestingly, known previous efforts for providing information focus a specific user, or specific devices wielded by the user, and are heavily device-centric or application-specific; asset tracking for example. The previous efforts fail to appreciate that information, services, applications, or other types of ambient data can be zone-centric where a zone can be treated as a distinct, manageable zone object where each instantiated zone object is capable of hosting one or more persistent services operating as an application. Further the previous efforts fail to provide for infrastructure capable of support many zones owner or operated by different owners.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Thus, there is still a need for zone management systems and zone application management.

### SUMMARY OF THE INVENTION

The inventive subject matter provides apparatus, systems and methods in which one can create and manage a zone as a persistent application where individual devices operate as I/O devices for the zone. Such approaches significantly reduce development complexity of context-aware computing environments, or allow engineers and developers to rely on defined zone structured to expedite development or testing processes. One aspect of the inventive subject matter includes a zone management system comprising a zone database, a device interface, and a zone server. The zone database is preferably configured to store one or more zone objects where each zone object represents a zone defined according to desired criteria specified as a function of an attribute space (e.g., geo-location, time, demographics, etc.). Additionally, zone objects can include one or more defined services that can be persistent and representing the capabilities or responsibilities of the zone. It should be appreciated that each zone object could have a different owner, thus giving rise to infrastructure allowing for many zones to exist and function contemporaneously even though the zones can be independently owned or managed. Each zone can be considered a distinct manageable object operating as an application having one or more persistent services once the zone is instantiated. The device interface allows elements of the zone management system to communicate with one or more electronic devices that are contextually relevant to the zone. The zone server can obtain device attributes from the electronic devices, image data or sensor data for example, and compare them to the properties of one or more zone objects to determine if the electronic devices are contextually relevant to the zones. For example, the zone server can use the device attributes (e.g., time, location, user identify, etc.) to derive a device context. If one or more of the electronic devices are contextually relevant to a zone based on their device contexts, the server can identify at least one of the persistent services from the zones as being relevant to the device context. The server can then configure the electronic device to participate with the persistent service according to the device context or other parameters.

Another aspect of the inventive subject includes a zone management system that allows users to engage with context-based zone services through recognition of contextual zone markers. Contemplated system can also include a zone database, device interface, and zone server as discussed above. The zone database can be configured to store zone objects as distinct management objects where each zone object includes zone context criteria and a plurality of context-based persistent services. Once a zone object is instantiated as a zone object, its context-based persistent services can be offered to electronic devices via the device interface when the device is considered contextually relevant. For example, the zone service can receive image data representative of a zone marker (e.g., barcode, QR code, symbol, logo, image, etc.) from the device. The zone server recognizes the zone marker as being associated with one or more instantiated zones. Further, the zone server derives a device context from device attributes where the device context can be used to select which of the instantiated zone's context-based persistent services are relevant to the device. The service can obtain contextual service information from the select service and configure the electronic device to enable interactions with the service information.

Yet another aspect of the inventive subject matter includes methods of managing zone applications. The methods can include providing access to one or more zone management servers offering zone management functions to a zone manager. Further, the zone management server can couple with a zone database configured to store zones as zone objects. Methods can further include presenting a zone management interface (e.g., a rendered GUI, a web site, a Application Program Interface (API), a context rule engine, etc.) to a zone manager. Another step of the methods includes allowing the zone manager to modify a zone object via the zone management interface. Example types of management functions provided by the zone management interface that can be used to modify zone objects include zone creation, zone deletion, zone editing, service editing, or other types of functions. The methods further include instantiating a zone as an application according to the properties of the zone object where the zone can be instantiated on a dedicated server with other zones, by itself on a single server, within a dedicated virtual machine, in a cloud-based service, or on other types of computing systems. The methods can further include configuring one or more electronic devices to be receptive to the zone application upon detection that the devices are contextually relevant to the zone.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of zone management ecosystem.

FIG. 2 illustrates instantiation of a zone from a zone object operating as a template.

FIG. 3 illustrates an electronic device capturing an image of a zone marker and interacting with a context-based persistent service of an instantiated zone.

FIG. 4 is an overview of a zone management system implemented by FLYBITS™, Inc.

FIG. 5 is an example zone management interface.

FIG. 6 is an example of zone editing tools.

FIG. 7 illustrates editing zone preferences.

FIG. 8 illustrates managing roles, service providers, or users.

FIG. 9 illustrates searching for users.

FIG. 10 illustrates provisioning service providers for a zone.

FIG. 11 presents a set of example service or application templates that can be associated with a zone.

FIG. 12 illustrates how service templates can be dragged-and-dropped into a zone object.

FIG. 13 illustrates creating a profile template for a zone.

FIG. 14 illustrates fleshing out a profile template for a zone.

FIG. 15 presents an example of a mobile zone attached to an emergency vehicle.

FIG. 16 presents an example of service activation as a user moves from zone to zone.

FIG. 17 illustrates device management features that can be bound to a zone.

FIG. 18 presents an example of defining points-of-interest within a zone.

FIG. 19 illustrates points-of-interests with routing information within a zone.

FIG. 20A presents an example of a context-based zone marker.

FIG. 20B presents examples of marker-based and context aware navigation among points-of-interest in a zone based on the zone marker of FIG. 20A.

FIG. 21 illustrates relationship-base privacy rules.

FIG. 22 illustrates sending a real-time message to zone participants.

FIG. 23 presents an example of automatically creating a zone based on a building floor plan.

### DETAILED DESCRIPTION

It should be noted that while the following description is drawn to a computer/server based zone management systems, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, Wi-Fi, 3G, LTE, or other types of IP-based and packet switched network.

One should appreciate that the disclosed techniques provide many advantageous technical effects including generating and sending one or more zone-based signals from a zone management system to electronic devices. The zone-based signals/beacons can be transmitted over a network (e.g., wired, wireless, etc.) to the electronic device where the zone-based signals configure the electronic devices to participate in zone-based applications.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Further, within the context of this document “coupled to” and “coupled with” are also used to mean “communicatively coupled with” over a network, possibly via one or more intermediary nodes.

The following discussion describes the management of “zones”. A zone can be considered a virtual object having extent and overlaid on aspects of the real-world where the zone provides access to one or more context-based services. A zone can be defined in terms of criteria that depend on a multi-dimensional attribute space. The attribute space can be used to define a zone's extent across the real-world in terms of attribute values within the attribute space. The attribute space can comprise many different dimensions including: geo-location, time, position, orientation, identity (e.g., device ID, user ID, zone ID, etc.), weather, temperature, pressure, motion (e.g., speed, velocity, acceleration, jerk, etc.), demographics, value, density, rights, regulations, relationships, resources, news events, or other types or classes of parameters that can be considered a dimension. A simple zone could comprise zone context criteria that depend on geo-coordinate attributes, possibly including a geo-fence. Zones are distinguished from a geo-fence because a zone is a distinct manageable object that includes one or more services that can be persistent and that can operate alone or collectively as an application independent of users or devices. Geo-fences lack such services. Still, users or devices can participate with the zone if permitted where the user can participate with a zone based on priority, access levels, relevant services fetched for the user, manual selection, or other conditions. A zone can also be considered a hardware/software system providing layered services, advanced data structures, testing infrastructure, simulating infrastructure, development environments, software components, sensor arrays, or other complex objects. One should appreciate that a zone object intrinsically has value due to its extent over the attribute space or the application services it can provide. Thus, the disclosed zone management systems or infrastructures can enforce rights or exclusivity with respect to each instantiated zone's attribute space boundaries even when rights or exclusivity is enforced among the zones owned by different zone owners.

### Zone Management Overview

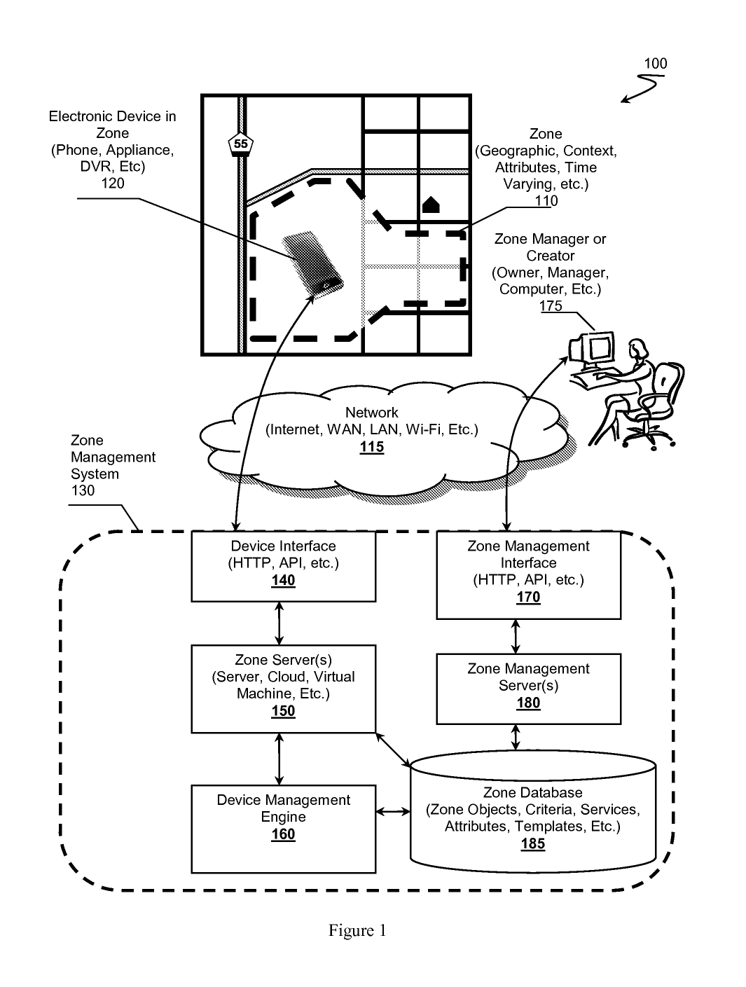

FIG. 1 presents a zone-based ecosystem 100 where a zone management system 130 operates to manage one or more zones 110. In the example illustrated, a zone 110 has been defined and instantiated to have an extent over a geographical region and to comprise one or more defined services or applications offered through zone server 150. When an electronic device 120, a cell phone for example, is found to be contextually relevant to the zone 110, the zone management system 130 can ensure the electronic device 120 can participate with the instantiated zone 110. Example electronic devices 120 capable of interacting within ecosystem 100 can include a tablet, a computer, a vehicle, an appliance, a cell phone, a smart phone, a mobile computing device, a robot, a sensor, a point-of-sales terminal, a kiosk, a gaming console, a digital sign, a security systems, a vehicle, a medical device (e.g., pacemaker, monitor, etc.), or other types of devices. Some embodiments include a device management engine 160 configured to provide platform-specific applications, handlers, or other data that can be sent to the electronic devices. For example, device management engine 160 can provide Android® apps (e.g., native application, drivers, operating system modules, scripts, etc.) that can be activated, cached, or installed within and Android-based device 120 to interact with persistent zone services.

Zone management system 130 includes a zone database 185, a device interface 140, and a zone server 150. The device interface 140 allows the elements of the zone management system 130 to interact with the electronic devices 120 associated with a zone 110 over network 115 (e.g., the Internet, cellular network, WAN, LAN, VPN, PAN, etc.). In some embodiments, the device interface 140 comprises a communications protocol such as HTTP(S) or XMPP server while in other embodiments the device interface 140 can also function via a wired or wireless interface, possibly a cellular interface. It is also contemplated that the device interface 140 could include an API into an operating system or middleware through which a zone server 150 can communicate with the electronic device 120. All device interfaces 140 are contemplated.

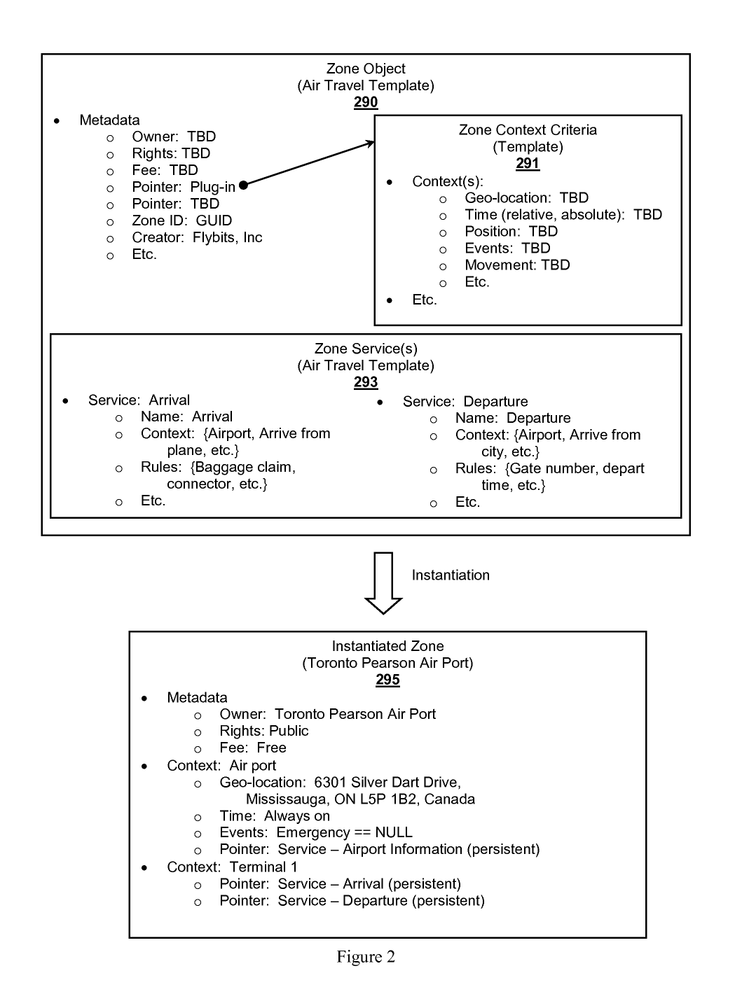

Zone database 185 is preferably configured to store one or more zone objects, among other objects in ecosystem 100, representing a desirable zone capable of being instantiated as represented by zone 110. Example zone databases 185 can comprise a cloud-based storage array, a search engine, a distributed database, a local database, a data store on electronic device 120, or other forms of databases. Zone objects can be separately managed as distinct objects and can include a plurality of properties, possibly stored as metadata, describing the nature of a corresponding zone 110. For example, the zone properties can include metadata referencing aspects of the zone, possibly including time of creation, zone owner identity, zone manager identity, zone identifier (e.g., GUID, UUID, name, etc.), subscription fees, account parameters, or other information. Another example of a zone property includes zone context criteria describing the extent of a zone with respect to an attribute space as discussed further with respect to FIG. 2.

Zone management systems 130 preferably include one or more zone management interfaces 170 through which zone managers (e.g., zone owners 175) can construct or manage their zones via a zone management server 180. In the example shown, zone management server 180 is illustrated as distinct from zone server 150. However, in some embodiments the zone management server 180 could be the same server as zone server 150. In more preferred embodiments, the zone management system 130 operates as a for-fee service where zone owners 175 use the management interface 170 to define their zones or pay for access to their zones. It is also contemplated that end consumers can also pay for access to zone 110 through zone management server 180. The zone management interface 170 is configured to offer the zone manager 175 many zone management functions. Example zone management functions include zone creation, zone editing, zone deletion, zone activation, zone deactivation, zone synchronization, zone service synchronization, zone replication, service definition, zone criteria definition, context definition, context plug-in management, electronic device control, electronic device management, electronic device native application management, zone role definition, zone profile definition, paying zone fees, bidding on zones, auctioning zones, attribute space definition, or other types of management or administration functions.

Especially interesting zone management interfaces comprise a geographical zone definition tool. For example, the zone manager 175 can be presented with a map, possibly provided by Google® maps or even StreetView™, within a web browser or windowing interface. Zone manager 175 can then construct a geo-fence or a geographical object around an area on the map to create geographical boundaries for their zone 110. The geographical zone definition tool can further be used to define zone boundaries based on many different factors including a volume (e.g., area and altitude), building floor plans, or other information. Example properties that can be used when establishing boundaries in the zone definition tool include a map, a floor plan, a topology, a political boundary, a contour, an overlay, a street, a restricted air space, an air space, an area, a volume, an object (e.g., an appliance, sign, sculpture, building, highway, LED lights, etc.), or other items.

Zone management interfaces 170 can also provide one or more zone editing tools that allow a zone manager to modify their zone 110 to fit their needs. For example, the zone editing tools can be used to modify or alter the boundaries of the zone 110 or the time-based duration of a zone 110. It is contemplated that some zone owners 175 might wish to bind their zones to a specific coordinate or even to an object (e.g., emergency vehicle, a moving object, person, etc.). For example, zone 110 could be bound relative to the GIS coordinates of a person's cell phone. Example editing functions that can be offered to zone managers 175 include zone re-dimensioning, zone or service relationship management, generating zone analytics, report zone analytics, exporting zones, importing zones, activating zones, drag-and-drop service provisioning, deleting services, profiling, or other types of zone modifications.

Zone server 150 can instantiate a modified zone when instructed. In some embodiments, the effects of a modified zone can be experienced in substantially real-time. For example, an owner 175 of zone 110 around a shopping mall might allow a shop owner to advertise in the zone. The zone owner 175 can create a new service for the shop owner where the new service provides promotional information to shoppers in the mall. As soon as the new service is instantiated, the zone server can push the promotional information to all participants in the mall zone in substantially real-time.

FIG. 2 provides additional details with respect to instantiating zone object 290 as an instantiated zone 295. Zone object 290 is presented as an air travel template zone, which can be considered a type of zone profile. One or more zone managers can utilize such templates for creating or instantiating desirable zones. For example, the zone manager of an airport can log into the zone management server and select zone object 290 as a template for creating a zone for their specific airport by populating the fields of the profile template. Once fleshed out, the zone server allows the zone owner to instantiate the zone object as instantiated zone 295, also referred to as zone 295.

Zone object 290 can include one or more features as illustrated. Zone object 290 can include zone metadata describing the nature of zone object 290. The metadata show can include one or more attributes along with possible corresponding values if necessary. Further, metadata can include empty or NULL fields (see the fields having values of “TBD”) that can be defined upon instantiation of zone object 290 as instantiated zone 295. For example, the “owner” or “rights” metadata represent attributes that have a name, but are not yet assigned a value. Additionally, the zone metadata can also include attributes that are defined a priori. For example, the “creator” attribute represents the entity that created the actual zone object as a template. Such literals or permanent attributes can also be present within a corresponding instantiated zone. Additional metadata can include fees to be paid for accessing zone object 290 or corresponding instantiated zones 295, pointers to other objects in system (e.g., zone context criteria, services, plug-ins, profiles, etc.), zone object identifiers, or other information.

Zone object 290 can also include one or more zone context criteria 291 that can be used to outline the extent of a corresponding instantiated zone. In the example show, zone context criteria 291 are also presented in template form. Zone context criteria 291 are defined in terms of possible conditions or possible requirements related to an attribute space. In some embodiments, the attributes space adheres to a common, possibly normalized, namespace through which various objects in the system can be compared to each other.

Zone context criteria 291 represent multi-dimensional requirements or optional conditions indicating the extent to which a zone overlays on the real-world. For example, a geo-fence can be used to describe a logical geographical boundary of a zone with respect to a set of geo-coordinates. Such geo-fences can include multiple boundaries, contours, altitudes, or other boundary limitations. One should appreciate that zone context criteria 291 can depend on other attributes in the attribute space beyond mere geo-location or geo-coordinates. Additional attributes that can be used to define a zone boundary in a physical attribute space or a logical attribute space include time, position, orientation, identify, weather, temperature, pressure, motion (e.g., position in time, speed, velocity, acceleration, jerk, etc.), demographics, value, density, rights, regulations, relationships, resources, news events, or other factors.

Consider, as an example, a zone object 290 defined as an advertising zone. The zone can have an extent covering a physical space, the floor plan of a mall for example, and can have an extent with respect to number of shoppers in the mall falling within a key demographic. Thus, the zone criteria 291 can be defined in terms of many zone attributes according to the attribute space. Still, further one should appreciate that zone types can have different attributes spaces depending on the nature of how the zone object is to be configured. Thus, each market type could adhere to its on namespace or ontology. For example, a medical zone would likely have a namespace having attribute names and values that are well known within the medical market, while a game zone would likely have a substantially different namespace.

Zone context criteria 291 can be considered to form one or more contexts considered relevant to the zone or zone services 293. In the example shown, the contexts are illustrated as a simple set of attribute-value pairs. However, the contexts can be considered a set of boundaries defined according to the dimensionality of the attribute namespace. The contexts could be represented as an N-tuple of conditions that depend on the namespace or even as a vector where each member of the vector corresponds to the dimensions of the namespace.

Zone objects 290 can also comprise one or more zone services 293, also shown as a template, representing one or more applications bound to the zone. The services 293 can cover a broad spectrum of capabilities or responsibilities of the zone. Example services can include providing access to multi-media objects (e.g., video, music, images, etc.), native or binary applications, web components, map or geographical based interfaces, communication components, feedback interfaces, notifications, reminders, appointments, sensor access, camera access or other types of services. Although the example services are listed as providing access to capabilities to the electronic device, the defined services can provide the zone access to information from the electronic device. A zone can gain access to the device sensors, device security features, device or user identity, device application outputs, or other device information. One should appreciate that defined services 293 can include an application per se rather than basic actions where the zone is, in fact, an application platform. For example, a zone could be constructed to operate as virtual game world. In view that the zone operates as a services platform or as an application platform, in a very real sense, the electronic devices can be consider I/O ports of the zone in a similar fashion that USB ports or serial ports are I/O ports for a computer. To continue with the airport template example, zone services 293 are illustrated as one or more possible applications that can be used by an airport; an arrival service available for those engaged with airport arrivals and a departure service available for individuals interacting with airport departures.

Zone services 293 can also include attributes or properties that describe the nature of the services. Each of services 293 can include their own context as well to indicate which service is should be identified by the zone server as being contextually relevant to a device context. For example, the zone server can compare the device attributes of the device context to the contexts of the available services to determine with which of the persistence services a device can participate. In the example shown, the contexts of services 293 have fields that require population upon instantiation.

Once a zone owner obtains or populates fields of zone object 290, the zone server can allow the zone owner to instantiate zone object 290 as instantiated zone 295, possibly by activating corresponding services 293 as persistent services. In the example shown, the zone server instantiates zone 295 by creating an actual instance of the zone through populating various fields of the metadata, attributes, contexts, services, or other features.

One should appreciate that instantiated zone 295 represents a simple example for illustrative purposes and represents a possible zone associated with the Toronto Pearson airport. Each instantiated zone would have its own set of field values that target the specific market for the zone. A simply example of a different field value would include the name of the zone; the name of the airport for example.

The services can be activated as persistent services through various techniques. As referenced previously the services can be considered applications or even portions of applications in a distributed execution ecosystem. For example, the persistent services could be instantiated for a zone by launching or activating a web services at a specific domain (e.g., URL, TLD, etc.) or even port assignment on a web server. The web server could comprise an actual server local to zone's geographic location if it has one, a remote server, or even a cloud-based implementation. Further, the persistent services could also include one or more APIs (e.g., web services, remote procedure calls, etc.) through which an application on an electronic device can interact with the service. Regardless of how a zone server launches or otherwise activates the persistent services, they come into existence and are available for consumption by electronic devices that are considered contextually relevant to zone 295 and its services.

Within the airport context, instantiated zone 295 has several contextually relevant persistent services. First, when an electronic device is considered to fall within the context of the airport (i.e., being physically located at the address of the airport or within an airport-defined geo-fence) the electronic device can consume the airport information persistent service because the device's context is relevant to the information service. Second, within a Terminal 1 context of the airport, there are two persistence services; an arrival service and a departure service. One should appreciate that each service exists regardless of the presence of devices and are readily consumable by the devices depending on their contexts. The arrival services can present connecting flight information, baggage claim information, schedules, weather, or other information. The departure service can provide flight information, gate numbers, delays, or other information related to departures. If a device is a passenger's device and arrives at Terminal 1 from a plane, then the device would be notified of the availability of the arrival service because the context of the device is considered to be relevant to an arriving passenger. Alternatively if a person is in Terminal 1, but is not a passenger and arrives from the street, they might be interested in the arrival services, which might allow the person to determine arrival flight information of a loved one. Additionally, the non-passenger might also be interested in departure services to aid in dropping off a loved one. If a passenger arrives from the street at Terminal 1, then their device can be configured to consume the departure services. Thus, instantiated zone 295 includes multiple or a plurality of context-based persistent services that can be consumed by users based on each user's context with respect to the zone. Therefore, each user can be presented with their own relevant set of services: the arriving passenger might only see the arrival services, the departing passenger might only see the departure services, and the non-passenger might see both arrival and departing services even though all services are persistent and operating.

A zone server can maintain zone 295 through one or more zone profiles. Zone profiles can be considered a purpose or a core function of the zone 295. In some embodiments, a zone profile is defined as a function of one or more zone profile templates that can be fleshed out during the creation of the zone 295 via zone object 290. Example zone profile templates can include an airport template, a public transit template, a conference template, a social networking template, an office template, a dinning template, a gaming template, an entertainment template, a shopping template, a travel template, or other types of templates. For example as illustrated, a zone owner for the Toronto airport can use the airport template to build one or multiple zones for the airport. The zone owner for John Wayne airport in Orange County, Calif., could use the same template to create a zone for their airport. Although the templates are the same, the actual zone profiles would be very different based on their defined zone context criteria. The geographical boundaries for each airport will be different. Still, some aspects of the profiles might be similar: each zone airport profile might include participant zone roles associated with devices or device users; passenger, employee, crew, or security, for example. This means that using these zone profiles, the core business logic of each entity can be used and specific business rules and customizations can be defined on top of these templates. The participants in each zone will be using these profiles to customize/retrieve relevant services; airport services, arrival service, departure services, etc. Suitable techniques that can be adapted for use with these templates are described in the Applicant's own work in U.S. patent application publication 2011/0125850 to Rahnama et al. titled “Method, Apparatus and System for Social Networking”, filed as an international application on Mar. 11, 2008.

Although FIG. 2 illustrates zone object 290, zone context criteria 291, and zone services 293 as templates, one should appreciate that such objects do not necessarily have to be templates. In some embodiment, zone object 290 and associated components could comprise a standalone zone that comprises sufficient definitions (e.g., properties, attributes, executable code, etc.) to allow a zone server to simply bring the zone into existence by monitoring contextual relevance of electronic objects and by activating the persistent services of the zone. Thus, zone object 290 could be saved or backed up and re-instantiated as desired. One should also appreciate that the instantiated zones can be managed individually or as a grouped as manageable objects. Treating each zone object or instantiated zone as distinct manageable objects is considered advantageous because each object has intrinsic value to the consumer base, which allows for such objects to be bought, sold, traders, licensed, individually modified, or otherwise monetized.

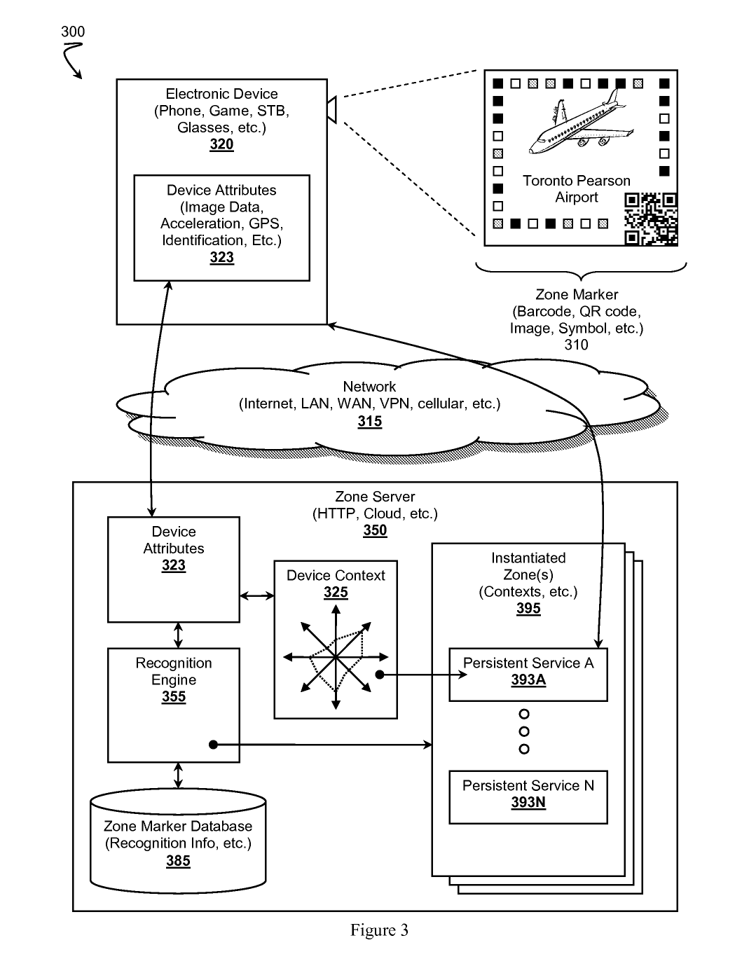

FIG. 3 provides additional details regarding the process through which electronic device 320 can interact with zone-based ecosystem 300. In the example shown, electronic device 320 captures image data representative of zone marker 310. The image data, along with other device attributes 323, can be sent to zone server 350 over network 315 for analysis. One should appreciate that electronic device 320 can be configured to operate as zone server 350 or include roles or responsibilities of zone server 350 if desired and under conditions where electronic device 320 has sufficient resources. For example, subject to bandwidth limitations, electronic device 320 could derive device context 325 from device attributes 323, which could include the image data, itself and send the device context 325 to zone server 350 over network 315.

One should appreciate that device attributes 323 can represent a broad spectrum of data modalities, including modalities beyond human perception. Human perceivable data modalities can include data that represents images, sound, touch, smell, or even taste. Examples of non-human perceivable data modalities include location, demographics, time, events, orientation, news events, or other types of data.

The zone server 350 represents the infrastructure on which an instantiated zone 395 is instantiated where the server 350 can be a dedicated piece of hardware, a virtual machine, or other configuration of hardware and software. Example infrastructures that an can be used as a zone server include a cloud-based service (e.g., Amazon® EC2; Microsoft® Azure, Google® Cloud, etc.), a for-fee based service, an connection-oriented or a connection-less server (e.g., HTTP, UDP, etc.) , a peer-to-peer service, a privately hosted service, a virtual machine, a zone-specific virtual machine, an access point, a cell phone hot spot, or other computing infrastructure.

In the example shown, instantiated zones 395 can operate as customizable and reconfigurable Platform-As-a-Service (PAS), Software-As-a-Service (SAS), or even Infrastructure-As-a-Service (ISA). Once a zone 395 is launched, the zone server 350 ensures that the zone 395 and its services 393A through 393N, collectively referred to as persistent services 393, maintain persistence according to the zone criteria, zone rules, or other zone properties. As stated above, one should keep in mind that the roles or responsibilities of zone server 350 can be distributed across other elements in the system include networking infrastructure or even electronic device 320. For example, electronic device 320 could operate as a Personal Area Zone (PAZ).

The zone server 350 is configured to obtain device attributes 323, which can include image data representative of zone marker 310, from the electronic device 320 via the device interface. The device attributes 323 can be obtained through various techniques including a push model, pull model, polling model, or other communication techniques. In more preferred embodiments, the electronic device 320 can establish a connection (e.g., a TCP/IP connection, a session, an asynchronous connection, etc.) with a zone server 350, possibly via a thin client or operating system module, and keeps the connection open. Once the connection is established, the device 320 and zone server 350 can maintain the connection. When context dictates, the zone server 350 can push service information from persistent services 393 or other sources to device 320. Using a push model for information is considered advantageous due to low communication overhead rather than a query-based approach where the device 320 constantly requests updates or polls zone server 350. As the device 320 moves from one zone to another zone, the device can 320 maintain the same connection to a zone server 350 or establish a new connection with a new zone server, possibly based on a hand-off algorithm. Regardless of the connection, the zone server 350 can obtain the device attributes 323 over the connection from the electronic device 320. Example device attributes can include device identify, device sensor data (e.g., GPS coordination, triangulation, accelerometer, heading, audio, image, video, etc.), ambient data, user identity, phone number, MAC address, make, model, operating system, version numbers, installed applications, or other device information. The server 350 can use device attributes 323 to determine if the device is contextually relevant to one or more zones 395 for which the server is responsible through one or more techniques.

Zone servers 350 can take on many different forms as referenced above. In some embodiments, the zone server 350 can manage multiple zones 395 for many different zone owners or manager as illustrated, while in other embodiments a zone server 350 can be dedicated to a single zone. For example, a retail chain store could construct zones 395 for each of their locations throughout the world. The zones 395 can be hosted on a single corporate zone server 350, or each location could host their own zone 395 on a dedicated server. In more preferred embodiments, the zone server 350 and other elements of the zone management ecosystem 300 are hosted as a for-fee service in a cloud-based architecture. An example zone management ecosystem capable of operating according to the techniques includes the Applicant's technology as represented by Flybits, Inc. (see URL www.flybits.com), which has yet to be launched at the time of this writing.

The zone server 350 can detect the electronic device 320 as being contextually relevant to the zone 395 by comparing the device attributes 323 to the zone's context criteria. In a simple example as illustrated in FIG. 3, the zone criteria could include a geographic boundary based on geographic coordinates, information from zone marker 310, or other factors in the attributes space. If the GPS coordinates (i.e., device attributes) of the electronic device falls within an attribute space boundary of one or more zones 395, then the device 320 can be considered as being relevant to the zone. One should appreciate that contextual relevancy can be quite complex and depend on many factors associated with the zone's attribute space beyond mere GPS coordinates.

As illustrated, zone server 350 uses the device attributes to derive device context 325, which can be used to identify or to select which of context-based persistent services 393 are contextually relevant to device context 325. Device context 325 is represented as a “signature” within a multi-dimension attribute space illustrates as a multi-axis graph where the dotted line represents how the current device attributes 323 map to the space. The signature can then be used to compare to the known contexts of zones 395 or persistent services 393 to determine contextual relevant. One should appreciate that device context 325 could also be represented as a vector, graph, matrix, N-tuple or other construct. For example, device context 325 can be constructed as a vector where each element of the vector corresponds to dimensions of the attribute namespace (e.g., geo-location, demographic, etc.). The elements of the vector can then be used as an index into a zone database to determine which of instantiated zones 395 are contextually relevant to device context 325.

Although device context 325 is presented with respect to electronic device 320, one should appreciate that device context 325 can also represent the user's context where the user context represents the circumstances that specifically relate to the user. A user context can leverage information or attributes associated with the user; personal preferences, demographics, user account or identification information, or other user related information. As discussed previously with respect to arrival or departure services, an example user context could include an indication if the user of electronic device 320 is a passenger of an airline based on airline account information or is a non-passenger.

Each zone 395 can also include one or more zone contexts defined according to the attribute space. One should appreciate the distinction between a zone context and a device context 325. A zone context represents the purpose, intent, goal, or factors associated with the specific zone 395. A device context 325 represents a scenario or circumstances in which the device 320 exists or operates as determined from the device attributes 323. Although zone contexts can include geo-graphical boundary conditions, the zone contexts can also include other attribute information relating to the nature of the zone 395 as discussed previously. For example, the zone context can be specified as a function of desirable demographics; men between the ages of 18 and 34 for example.

Zone contexts could be statically defined at the time of creation. For example, a zone creator can utilize a priori define contexts provided by the system when creating a zone. The zone context can then be edited, if desired, to better conform to the needs of the zone owner. Further, a zone context can be dynamic where the zone context varies with time or other attributes. A dynamic zone can depend on triggering conditions in time; absolute time or relative time. Additionally, a dynamic zone can depend on behavior patterns in time. Still further, each zone object can comprise or otherwise point to, via pointers (see FIG. 2), zone context plug-ins that can be used by a zone 395, or zone server 350, to aid in zone management. The pointers within a zone object can include API, URLs, network addresses, protocol addresses, or other types of pointers. Example zone context plug-ins include sensor plug-ins, inference engine plug-ins, rules plug-ins, roles plug-ins or other types of plug-ins. A context plug-in can include modules capable of defining one or more contexts to be associated with a zone. An inference engine plug-in can include modules that analyze one or more zone contexts 325 to identify possible patterns in time or behavior, which in turn can be fed back into zone server 350 to aid in construction of device contexts 325. The inference engine can leverage one or more styles of reasoning including deductive reasoning, abductive reasoning, inductive reasoning, or other types of reasoning to establish device context 325. A rules or roles plug-ins can include modules that have executable instructions beyond persistent services 393 that govern the behavior or policies of zones 395. For example, rules could include time-based activation or deactivation of zones 395, accounting or billing procedures, management actions, or other features. Use of pointers and plug-ins within zone objects allows zone managers to construct high complex, integrated zone applications offering a broad spectrum of zone capabilities.

Zone contexts can also be defined based on an application-specific ontology targeting one or more use-cases. A zone management server can recommend one or more ontologies based on the attributes in the attribute namespace used to create the zone boundary conditions. Further, the zone management server could recommend one or more namespaces that might be considered applicable to a zone context. For example, if a user selects a geographical boundary that includes one or more law offices, the zone management server can recommend a law office ontology suitable for construction a law office zone. The ontology can comprise example user profiles, user relationships, office profiles, or other information. Further, the management server can present a ranked listing of recommend contexts or ontologies based on the attributes used to define the zone's boundary conditions. To be clear, the term “boundary conditions” is used euphemistically to describe the extent of a context within the attribute space rather than a geo-graphical boundary.

Zone context plug-ins are leveraged by the zone server 350 to ensure the zone context is up-to-date or otherwise enforced. For example, a zone context sensor plug-in enables a zone 395 to monitor itself to determine its current context according to one or rules sets, possibly based on the zone context rules plug-ins. In a very real sense, zones 395 can be considered reflexive objects capable of self observation or modification, subject to the rules. The nature or types of information obtained by the sensor plug-in can vary widely. The sensor plug-in can obtain data directly from electronic devices 320 associated with the zone (e.g., security camera, cell phones, etc.), from news sources, weather stations, or other sources that provide data related to a zone.

The zone server 350 can also leverage a zone inference engine plug-in that analyzes data related to the zone. The inference engine can also operate according to one or more rules sets as desired to achieve desire results for the zone. An especially preferred type of an inference engine plug-in includes an Activity Recognition Engine (ARE) that attempts to detect identifiable behavior patterns among electronic devices associated with the zone or with collections or groups of electronic devices 320.

The zone rules plug-ins configure aspects of the zone (e.g., ARE, zone context, services, etc.) to operate according to design. The rules in the rules plug-in can be used to determine which electronic devices 320 will be permitted to participate in the zone services 393, which services 393 to offer, or other control aspects of the zone. An example rules sets could include a privacy rules set or policy under which the zone server 350 allows information to be exchanged among zone participants based on participant relationships. Consider an office zone where the zone is constructed to exchange messages among office workers. The privacy rules for the zone can restrict access to participants based on time, urgency, or other factors. For example, if it is after hours and a boss sends a message to an employee, the zone can hold the message until the next day to protect the privacy of the employee. This is achieved by processing the social relationships of the two zone members (i.e., employee and employer) and the communications rules defined in the office zone that restrict providing the message to the employee until the employee's cell phone is contextually relevant to the work place. Each of these context elements can be retrieved using proper context plug-ins and then sent to the ontology-driven ARE engine for processing. Further, the privacy rules might allow the employee's spouse to have visibility of employee at anytime during the day. Enabling information retrieval based on context is managed through the instantiated zone objects 395. For example, access to a spouse's location information might have improved characteristics (e.g., increase resolution, context, etc.) after official working hours are over while the employer might have reduced access after working hours. Thus, zone server 350 can restrict access to zone-related objects (e.g., zones 395, zone services 393, etc.) to zone owners according to zone owner authentication requirements.

Once the zone server 350 detects that the electronic device is contextually relevant to the zone, the zone server configures the electronic device 320 to participate with persistent services 393 according to the zone criteria (e.g., zone context, zone profiles, roles, etc.) and the device attributes 323. The zone server 350 can configure the electronic devices to participate in the zone through various methods. In some embodiments, the device 320 can comprise a thin zone client or operating system module that communicatively couples with the zone server 350 and that comprises service-type handlers. The service-type handlers allow the device 320 to participate with known types of services offered by zones. When the zone server 350 sends a signal over the network 115 to the device 320, the service-type handlers can be activated so that the handlers are receptive to the services 393 of the zone. Such an approach ensures that communication overhead remains lows. Still, it is also contemplated that zone server 350 can configure the electronic device 320 by provisioning the electronic device 320 with a platform-specific handler as a service-type handler. The platform-specific handler can be considered one or more native applications targeting the specific electronic device 320 (e.g., Android®, iPhone®, Playbook®, Windows®, PS3®, etc.). For example, a zone management system can include a device management engine (see FIG. 1, device management engine 160) that provides platform-specific applications, handlers, or other data that can be sent to the electronic devices. Still further, the zone server 350 can configure the electronic device 320 according to the zone's profile or the profile template.

As zone services 393 or zones applications become accessible to the electronic devices 320, the electronic device 320 can be configured to present an indication of the presence of the services 393. To continue the previous airport example, consider a scenario where a passenger enters an airport zone. The corresponding zone server can activate service-type handlers on the passenger's smart phone for check-in, directions, departure times, arrival information, or other services. Once the handlers are activated, associated icons or other indicators (e.g., visual, audio, tactile, etc.) can be presented to the passenger on the display of electronic device 320. Similarly, when electronic device 320 is determined to be no longer contextually relevant, the icons or indicators can be hidden or removed from the passenger's view. One should appreciate that presentation of such service indicators merely indicate that electronic device 320 is able to consume persistent services 393. Services 393 remain persistent regardless of the presence of electronic device 320.

Persistent services 393 can include active services or passive services. Activate services can configured to continue functioning even when no devices are present. Example active services, at least within an airport context, could include information services that readily update flight status data based on various feeds. Passive service can be considered to include services that remain static until they are engaged by an external entity, electronic device 320 for example.

Persistence services 393 associated with a zone 395 can also have properties affecting their behaviors. The discussion above indicates that services 393 operate within the attribute boundaries of the zone 395. Such services 393 can have properties indicating the services are a “zone-bounded” service. It is also contemplated that the services 393 can be “non-zone bounded” where the services can remain functional, at least for a defined period of time, while external to a zone boundary or outside a zone context. Referring back to the airport passenger example, the departure time information could be a non-zone bounded service allowing the user to interact with the zone without being within the geographic boundaries of the zone. Zone-based information from “non-zone bounded” services can also be retrieved through centralized search engines such as Google®. In such a case zone-enabled entities can highlight the presence of their zones when indexed or represented by search engines. If zone-enabled entities are accessed by search engines while the user is in the zone, “zone-bounded” services can be shown to the user.

Services 393 can also have properties indicating if the electronic device 320 can participate with services 393 when the electronic device is “on-line” (i.e., capable of communicating with the zone server 350) or “off-line” (i.e., not communicatively coupled with the zone server 350). For example, a native application can be provisioned on the electronic device 320 to capture information about or from a passenger while the passenger is in flight and is not near a zone. When the passenger lands, the local zone can establish a connection with the native application and the passenger information for the new zone can be downloaded to zone server 350.

An especially interesting embodiment includes those that utilize information related to zone marker 310. For example, zone server 350 can include a recognition engine 355 configured to recognize zone marker 310 from image data within device attributes 323. The recognition engine 355 can utilize one or more algorithms to analyze the image data to derive or decode features of marker 310. For example, in scenarios where marker 310 include alphanumeric, recognition engine 355 can leverage known optical character recognition algorithms. When marker 310 includes an image, logo, or other non-text object, recognition engine 355 can leverage algorithms such as Scale-Invariant Feature Transform (SIFT: see U.S. Pat. No. 6,711,293), Binary Robust Invariant Scalable Keypoints (“BRISK: Binary Robust Invariant Scalable Keypoints”, Leutenegger et al., Proceedings of the IEEE International Conference on Computer Vision (ICCV) 2011; www.asl.ethz.ch/people/lestefan/personal/BRISK), or others. Once recognition engine 355 derives relevant features from the image data, it can obtain marker related information from zone marker database 385 by using the features or image data characteristics as an index into zone marker database 385.

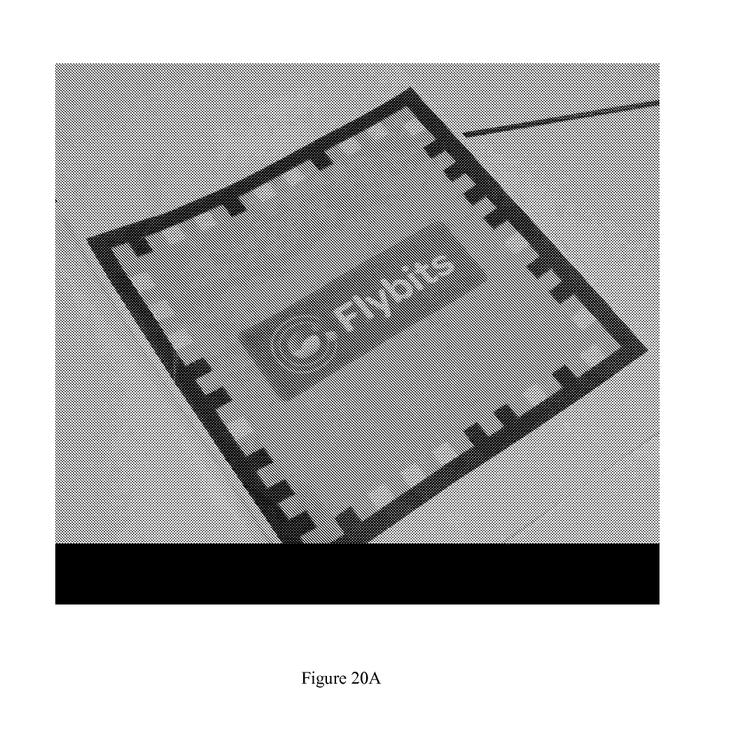

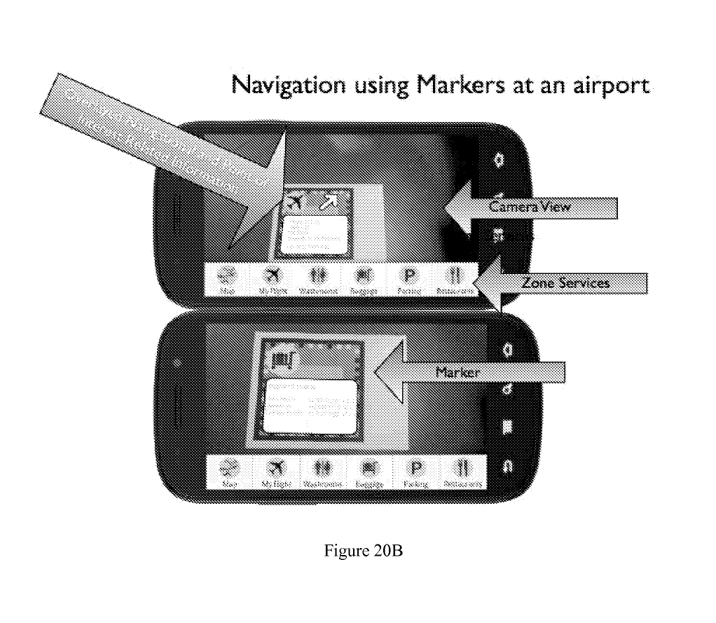

Although represented as having a log, proprietary border markings, and a QR code, zone marker 310 can take on a wide variety of characteristics (see also FIGS. 20A and 20B). Zone marker 310 can comprise logos, symbols, images, text, or other forms recognizable objects. In some embodiments, zone marker 310 could also include a person's face, a representation of a person's face, 3D object, photographs, or other types of objects beyond just symbols. Additional types of symbols could include a bar code, a matrix code, a 2D code, a maxicode, a high capacity color code, a data glyph, or other types of symbols.

Zone marker 310 can also be configured to include various forms of information or point to information based on the context of the user or electronic device 320. For example, the QR code could include a URL or other pointer to a network address where information can be objects. Alternatively, zone marker 310 could simply comprise a zone identifier or even a context-based persistent service identifier relevant to maker 310. In such cases, zone server 350 uses the zone identifier, possibly derived from device attributes 323, to determine the deployed location of marker 310. The location information can be folded into device context 325, which in turn can be used to select contextually relevant instantiated zones 395 or corresponding services 393. Further, zone marker 310 can include or point to information related to the zone owner, which gives rise to opportunities for advertising to consumers, accounting, or other actions. As suggested previously, the various identifiers (i.e., zone identifier, owner identifier, service identifier) can include a text-based name, a logo, a GUID, a UUID, a URL, a domain name, a network address, or other type of identifier.

In the example illustrated, zone server 350 obtains image data representative of zone marker 310 from digital attributes 323. Zone server 350 can also derive device context 325 from attributes 323. Further, zone server 350 uses the image data to recognize zone marker 310 as being associated with an instantiated zone 395, possibly an airport zone. Zone server 350 can use device context 325 to select at least one of persistent zone services 393 of instantiated zone 395 as being contextually relevant to device context 325 by comparing device context 325 to the contexts associated with the context criteria associated with instantiated zone 395. In this example, zone server 350 has selected persistent service 393A. For example, persistent service 393A could be a news service, a travel service, a game service, a navigation service, an advertisement services, a shopping service, or other type of service. Zone server 350 obtains contextual information from the context selected service and configures electronic device 320 to enable interactions with the contextual information. Example contextual information related to persistent services 393 could include account information, travel information, game information, purchasing or transaction information, routing or navigation information, application data or information, shopping information, or other types of data depending on the nature of persistent services 393. Electronic device 320 can be configured by zone server 350 by activating one or more service-type handlers on device 320, sending commands to device 320, or be simply sending consumable content (e.g., audio, video, apps, games, etc.) to device 320.

Persistent service 393A can represent an airport a context-based navigation service as triggered by recognition of zone marker 310. In some embodiments, when a zone 395 is created a zone creator can be given an option to identify points-of-interest within the geographical boundaries of the zone 395. Each point of interest can have an automatically generated zone marker 310 (e.g., bar code, QR codes, augmented reality codes, proprietary markers, etc.) assigned to the point-of-interest. The zone owner can place the physical zone markers 310 within the actual real-world location corresponding to the points-of-interest. When a user enters the zone 395 or becomes contextually relevant to the zone 395, the zone activates navigation services 393A on the user's device 320. The user can take an image of a marker 310 with their device 320 and the navigation service can provide directions to the user based on the marker 310 (see FIGS. 20A and 20B) based on their context (e.g., arriving, departing, visiting, movement, etc.). One should appreciate that such capabilities can be based on device or user context as well as zone context. For example, a passenger disembarking from a flight would likely obtain directions to a baggage claims from the marker 310, while a departing passenger would likely obtain directions to their flight gate from the exact same marker 310. In some embodiments, the direction or navigation routes around a zone based on the navigation markers can be constructed based on or a variant of Dijkstra's algorithm. This allows the provisioning of indoor way-finding solution without relying on radio beacons or triangulations. The zone driven system also allows the markers 310 to represent different information to different users based on their context. Also one identical marker 310 can behave or processed differently depending on its location, zone association, device context, user context, or other factors. This means that the exact same marker configuration could be presented within a travel context at the airport as well as being present in a shopping mall within a shopping context.

Another aspect of building a zone application or services can include defining one or more zone roles. A zone role represents one or more aspect that an electronic device 320, a user, or other zone participant can take on while interacting with the zone 395. The zone roles are preferably bound to the zone criteria or can be defined by a zone manager via a zone management interface. The zone roles can also vary widely from one type of zone to another. For example, in a law office zone available roles could include partner, attorney, associate, clerk, paralegal, or client. In an airport, available zone roles might include passenger, ticket agent, employee, crew, security, or other types of relevant roles. As electronic devices become contextually relevant to the zone, the electronic devices can be configured to take on one or more zone roles based on their device attributes 323. A zone user can also have multiple roles, which allows the user to gain access to multiple sets of zone services 393.

Users can be treated distinctly from their devices because a single user might shift from using one device (e.g., a smart phone) to using a different device (e.g., a handheld gaming device) while the user remains contextually relevant to the zone. Therefore, zone criteria can also comprise available user profiles that can be adopted by the user while they are participating with the zone. In more preferred embodiments, each user can also have an associated user-specific master profile that tracks information about the user: preferences, identify, behavior history, etc

The inventive subject matter is considered to include enforcing exclusivity of a zone based on the instantiate values of zone contexts within zones 395. For example, a zone owner could purchase ownership rights for a zone around a strip mall. Once purchased, leased, or otherwise paid for, no other entity can purchase the same zone subject to the exclusivity of the attributes boundary conditions. Additionally, a second zone owner could purchase ownership rights of a second zone defined in terms of a demographic, but only applicable to a specific zip code while not specifically bound to a geographic boundary in the zip code. Thus, although the second zone might lack explicit geographic boundaries, the second zone owner still has a valuable property. The two zone owners can work together through licensing or other negotiations to build a more complex zone 395 that can possibly leverage each other's services. The first zone owner can then sub-lease or allow third parties to create zone services or applications in the zone for a fee. One should appreciate that zones can have overlapping criteria (e.g., zip code and geographic boundaries), orthogonal criteria (e.g., geographic boundaries and demographic requirements), or other relationships that give rise to intrinsic value to zones.

A zone's attribute space boundary conditions give rise to interesting features within ecosystem 300. An astute reader will appreciate that the disclosed subject matter allows for instantiation of multiple zones that can be closely related within the attribute space or even overlap each other. A simple example could include two shopping zones that neighbor each other within a mall. A first store would desire that their customers would only receive shopping services (e.g., promotions, advertisements, contexts, coupons, etc.) for their store, while the second neighboring store would have such desires. However, GPS location signal resolution might not be able to fully distinguish the zones from each other, assuming they each have zone context criteria that depend on GPS coordinates. How would zone server 350 resolve which zone or zone service should be offered to consumers? Example suitable techniques that could be adapted for use with respect to geo-fences include the techniques describe in U.S. patent application publication 2010/0127919 to Curran et al. titled “Geo-Fence with Minimal False Alarms”, filed Nov. 21, 2008 and U.S. patent application publication 2011/0256881 to Huang et al. titled “Context-Based Reverse Geocoding”, filed Apr. 20, 2010. Unfortunately, these are not suitable when a zone context depends on an arbitrary attribute space.

The inventive subject matter is considered to resolving zone boundary conditions with respect to the corresponding attribute space. When the zone context criteria depend on defined attributes within the attribute space, zone server 350 can easily determine the contextual relevance of electronic devices with respect to a zone or its services based on the defined values. Zone context criteria can define a zone's boundaries based on define attributes that have well defined values in the attribute spaces. Examples defined attributes include demographic values, gender, age, phone ID, phone make, or other defined values. Define attributes can be obtained from electronic device 320, from user accounts (e.g., Amazon, Facebook, etc.), or other sources. Zone server 350 can clearly distinguish when device attributes 323 have are contextually relevant with respect to boundary conditions established based on defined attitudes. However, a zone's boundary conditions within the attribute space could depend on sensed attributes; GPS coordinates for example. Sensed attributes are typically measured. Consequently, sensed attributes within device attributes 323 can comprise a “fuzziness” or errors, which can cause zone server 350 to determine contextual relevancy with uncertainty.

When zone server 350 is uncertain as to which of multiple zones or services are relevant to electronic device, zone server 350 can resolve the uncertainty in one or more ways. In embodiments where multiple conflicting or competing zones could be considered contextually relevant based on sensed device attributes, zone server 350 can fall to analyzing defined attributes to resolve conflicts. If uncertainty is still an issue, then user preferences with respect to defined attributes could be used to resolve conflicts.

In other embodiments, zone server 350 can utilize information from zone owners to resolve possible uncertainty. For example, if two or more zones could be considered contextually relevant to a user of electronic device 320, zone server 350 could apply a fee-based resolution table to resolve conflicts. The fee-based resolution table could be derived based on amount paid, time paid, auction results, or other monetary factors.

Zone server 350 can also monitor behavior patterns of electronic device 320 by observing device attributes 323 with respect to time. Observed patterns can also be used to derive device context 325. For example, behavior patterns can be used to select a pre-caching persistent service 393 to ensure that electronic device 320 is provisioned with proper service handlers before electronic device 320 properly enters a zone. Such capabilities are considered advantageous when bandwidth might be limited or when patterns are well established (e.g., heading toward home, heading to work, heading shopping, etc.). Further, patterns can be used as a security measure by requiring electronic device 320 to move through various “secure” zones before one or more zones or services are unlocked for access. Such an approach can be considered a form of “zone knocking” before a user gain authorized access. In a similar vein, zone boundaries can secure features of an operating system. Perhaps a zone service could include an encryption service for an operating system running on electronic device 320 where the service only is engaged with the user is in the proper zone.

Zone Application Management

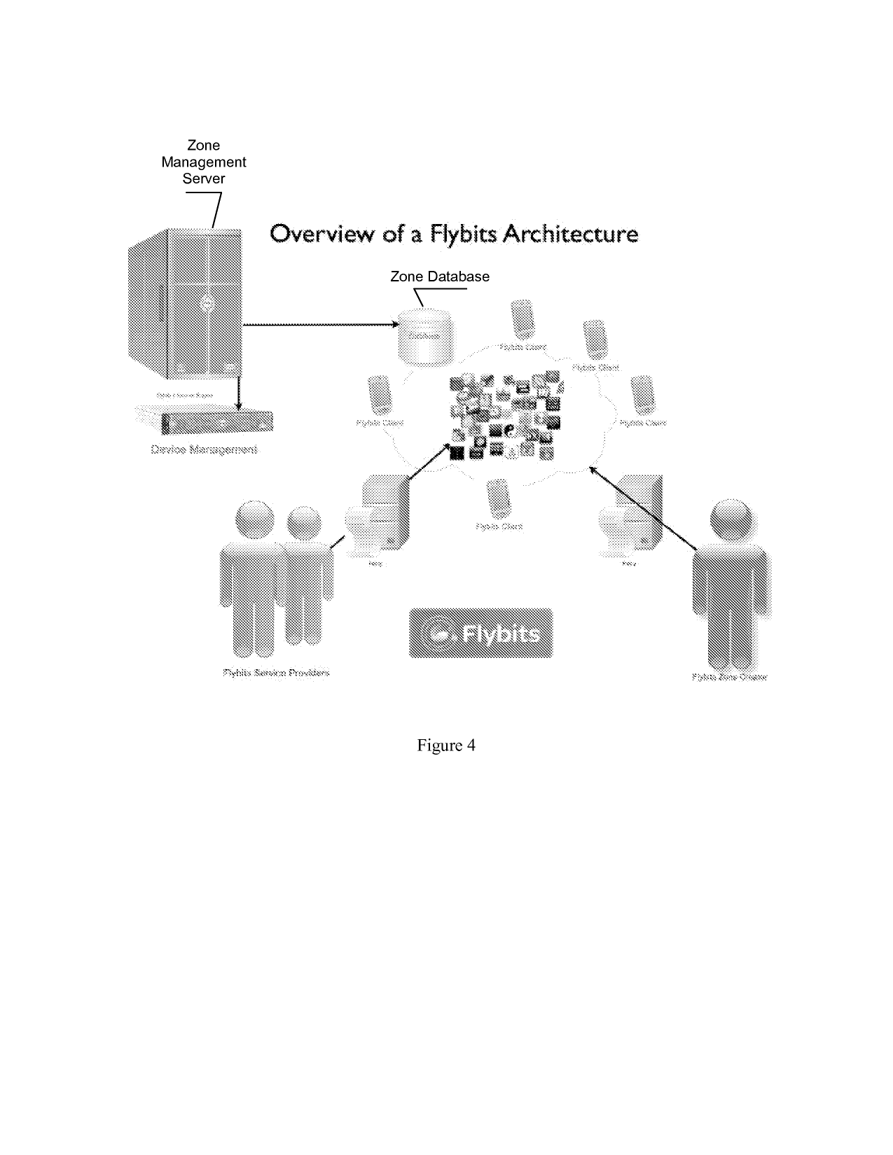

Another aspect of the inventive subject matter includes methods of managing one or more zone applications or services. A step of method includes providing access to a zone management server coupled with a zone database configured to store zone objects as illustrated in FIG. 4. The zone management server can be accessed by one or more entities over a network as a for-fee service. Thus, the method can further include charging a fee for accessing to the zone management system.

Charging a fee for access to the contemplated ecosystem can cover a broad spectrum of types of transactions. In some embodiments, a zone owner pays for a zone based on a calculated zone value attributed to the zone object. For example, a zone might be valued based on the geographical land area covered by a zone; cost per square foot for example. Further, the calculated value can be based on other attribute in the attribute space associated with the zone; cost for covering an aspect of a demographic. The monetary value assigned to an attribute space can be assigned by estimates, auctions, bidding, or other factors as desired. Some embodiments include conducting an auction for the zone where the auction could be for the entire zone, rights to the zone, portions of the zone, zone services, or other aspects of the zone.

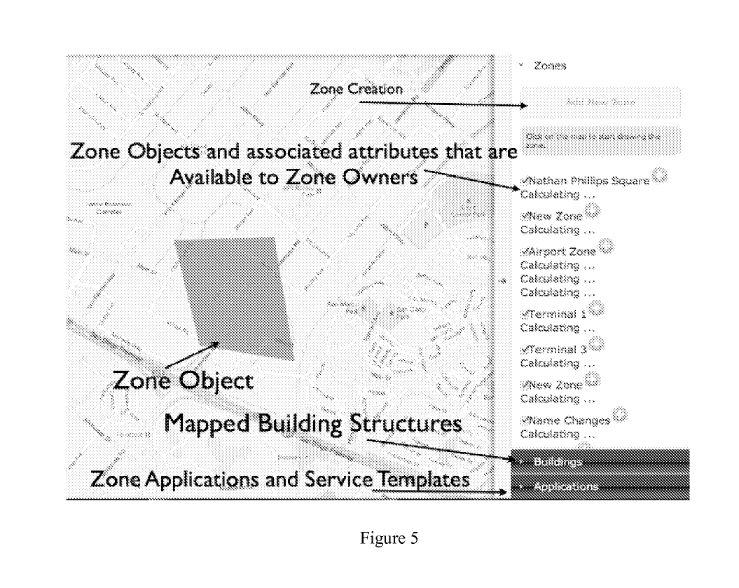

The method can further include the zone management server providing a zone management interface to a zone manager. The interface can be rendered within a browser for the zone manager utilizing drag-and-drop components as desired. FIG. 5 illustrates one possible zone management interface, which is currently implemented by FLYBITS, Inc. Although the interface can be rendered within a browser, the zone management interface could also comprise an API, a dedicated application, an Integrated Development Environment (IDE), or other types of interfaces. Further, a zone manager can include a human or a computing device configured to interface with the zone, possibly in an automated fashion. The zone management interface in FIG. 5 illustrates various features include a zone object defined on a geographic map, zone application or service templates, templates for creating zones from buildings, existing zones and attributes available to a zone owner.

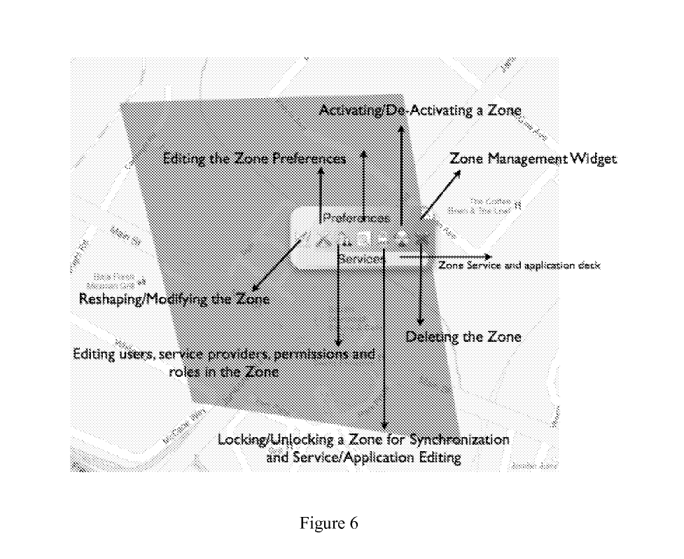

The method can further include allowing the zone manager (e.g., zone owner, administrator, computer-based manager, etc.) to modify a zone object associated with a zone via the zone interface. FIG. 6 illustrates the zone management interface where the zone management server presents the interface as a Graphical User Interface (GUI). The example illustrated comprises a screen shot of a GUI browser interface where the zone object is presented as a graphical zone object overlaid on a map. The zone object boundary presents the geographical boundaries within which electronic device can participate with the zone. One should keep in mind that the zone management interface can also include machine accessible APIs or other types of interfaces that allow automated access to the zone object. For example, zones can intercommunicate via the management APIs to alter each other's behaviors if required. For example, a franchise may develop zone rules on how certain retail information should be provisioned to its stores visitors. In this case, some of these services are synchronized between all zones and some are specific.

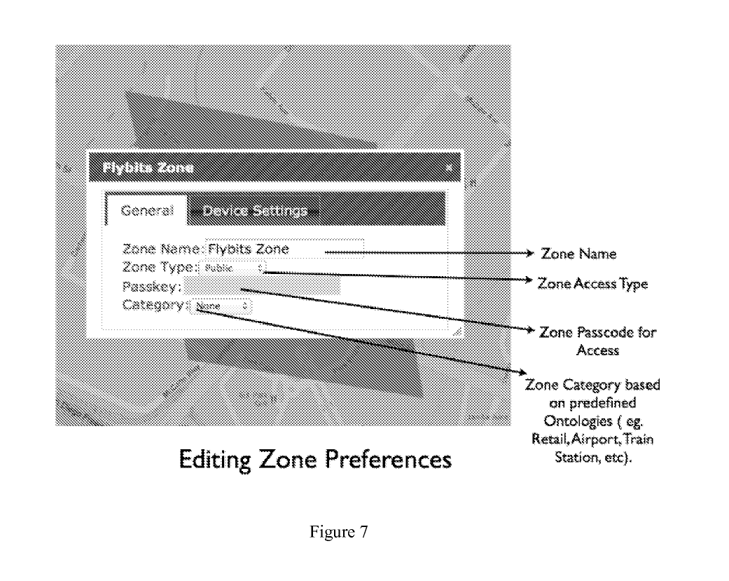

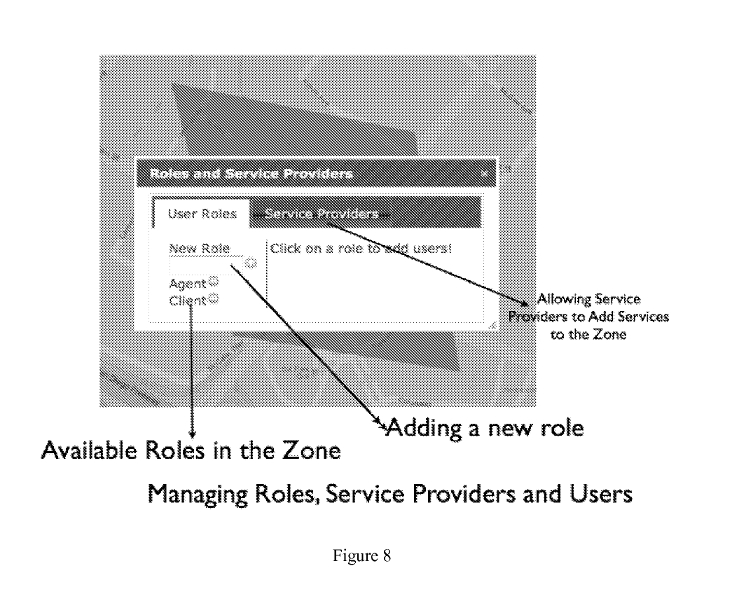

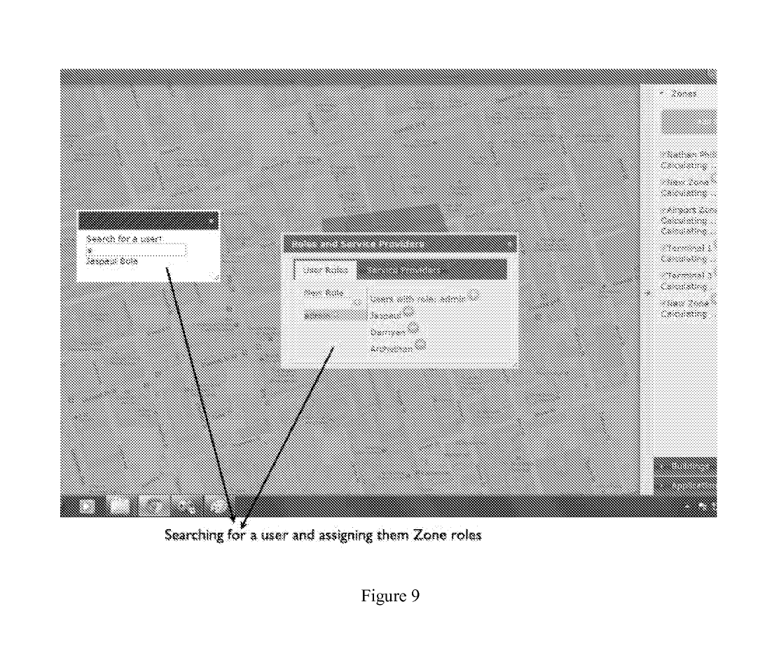

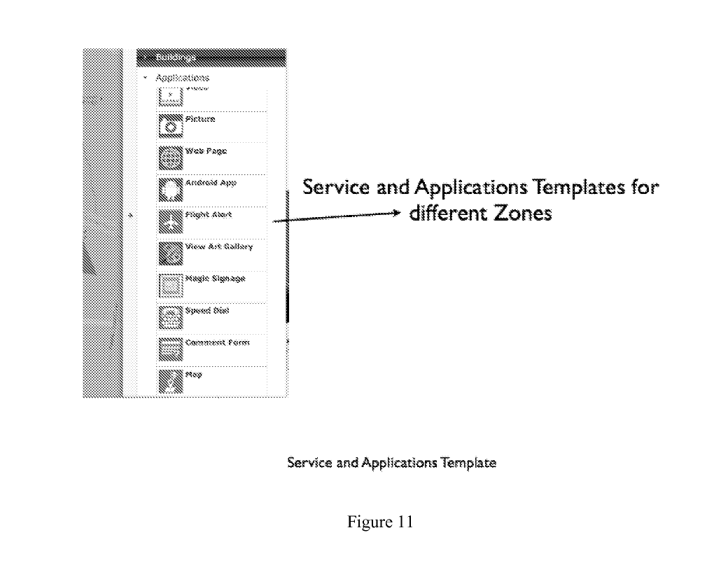

As illustrated in FIG. 4, the method can further include presenting one or more zone editing tools, labeled “zone management widget”, to the zone manager. The zone manager can access the various editing capabilities of the zone management interface via the tools. Example editing actions include reshaping or modifying the geometry of the zone; editing preferences (see FIG. 7); editing or searching users, services providers, permissions, or roles (see FIGS. 8, 9, and 10); locking or unlocking the zone for synchronization; editing services or applications; activating or deactivating zones; accessing services or application templates; deleting zones; or other actions. The method can further include presenting one or more zone service or application templates within the GUI to allow zone managers to quickly and easily create a zone application. FIG. 11 illustrates a set of possible templates that can be used to create zone including providing videos, pictures, web pages, native applications (e.g., “Android App”, “iPhone App”, etc.), flight alerts, art galleries, navigation marker service (i.e., “Magic Signage”), dialing information, speed dials, comments forms, maps, or other types of services that can be used to construct a zone application.

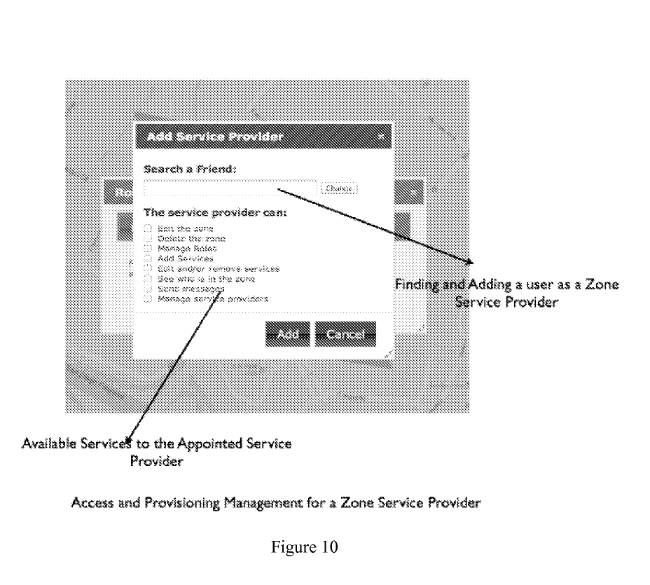

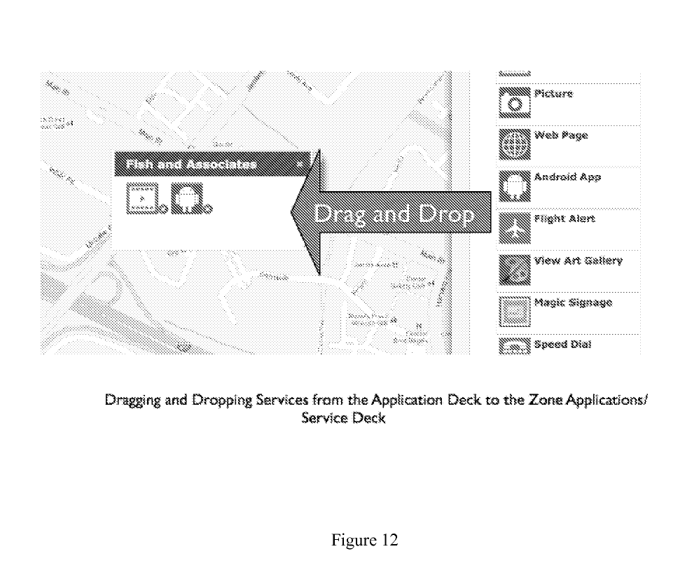

In especially preferred embodiments, the method comprises allowing the zone manager to provision services of the zone object by enabling the zone manager to drag-and-drop a service template onto the graphical zone object as illustrated in FIG. 12. The zone object has been opened in FIG. 10 as a box capable of receiving the templates for the zone object. The manager simply populates the zone object with one or more desired services. Although only service templates are illustrated, one should appreciate that new services can be created from scratch as desired, possibly based on a zone development kit.

The method further includes allowing the zone manager to modify the zone object by executing one or more of the available management functions presented via the zone management interface. Example management functions can span across a wide selection of actions targeting zones including zone creation, zone editing, zone deletion, zone activation, zone deactivation, zone synchronization, zone service synchronization, zone replication, service definition, zone criteria definition, context definition, context plug-in management, electronic device control, electronic device management, electronic device native application management, zone role definition, zone profile definition, attribute space definition, or other functions. Modified zone objects can be stored within the zone database as desired. The zone database may be centralized, distributed, ad-hoc, hierarchal, or other form of database.

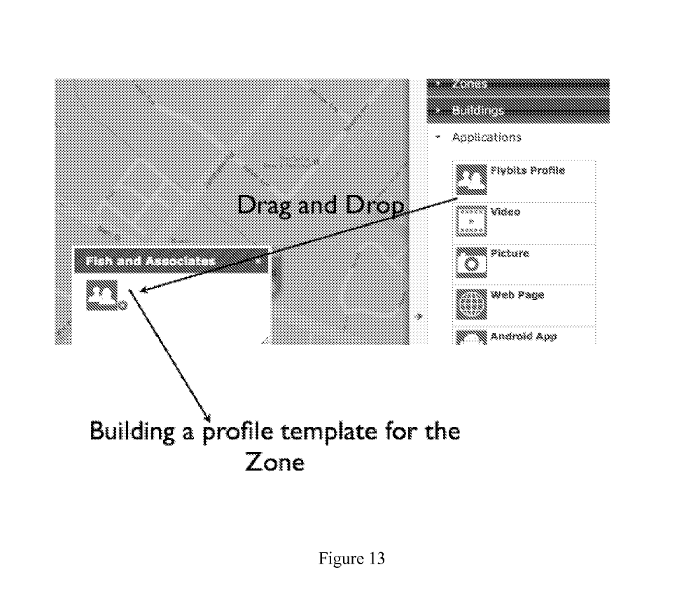

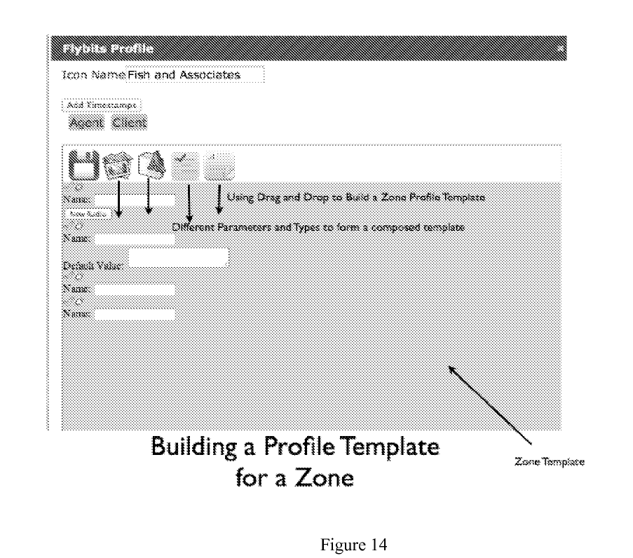

Consider a scenario were a zone manager wishes to build a zone profile for a newly created zone. The method can include allowing the zone manager to define a zone profile that can be bound with the zone via the zone object as illustrated in FIG. 13. The zone manager simply drags-and-drops a profile template into the zone object as shown. The zone manager can then use the zone editing tools to construct the zone profile as desired by adding fields and field values; names, radio buttons, time stamps, user profiles, or other types of properties. FIG. 14 illustrates a zone profile editing interface allowing the zone manager to flesh out requirements or optional conditions for the profile.

Modifying a zone, as mentioned briefly above, can include a broad spectrum of activities that affect a zone object. One example type of modification includes defining one or more user profiles that are associated with a zone. Referring back to FIG. 14, the current zone has two profiles, agents and clients, which have been defined for use within the currently defined zone. When a user's device becomes contextually relevant to the zone, the device or the device user can take on one or more of the specified user profiles according to the rules of the profile. In a similar vein the zone itself can have a defined role. Thus another example of zone modification includes defining at least one zone role; a transit zone, a gaming zone, or other type of zone. It should be appreciated that a zone can have multiple roles or that zones having individual roles can be combined to form a composite zone that inherits the roles of the individual zones. Yet another example of zone modification includes integrating one or more zone plug-ins into the zone object where the plug-ins can aid in defining the capabilities or operation of the zone. The zone plug-ins can be used to define a context for the zone through rules, roles, inference engines, sensor data acquisition, attribute space definition, or other factors. It is specifically contemplated that third party vendors can product zone plug-ins to contribute to zone feature sets through a zone development kit.

While the zone in under modification, it is contemplated that the zone can remain in an inactivated or editing state to ensure the consistency of service updates in the zones. When the zone is ready or when desired, the method further includes instantiating the zone as a zone application according to the defined or modified zone object. The zone can be instantiated on a zone server configured to host the zone capabilities or enforce the zone feature sets. The step of instantiating a zone can include launching the zone application on a dedicated server; on a cloud-based service as a PAS, SAS, or IAS; in virtual machine; or other suitable computing platform.

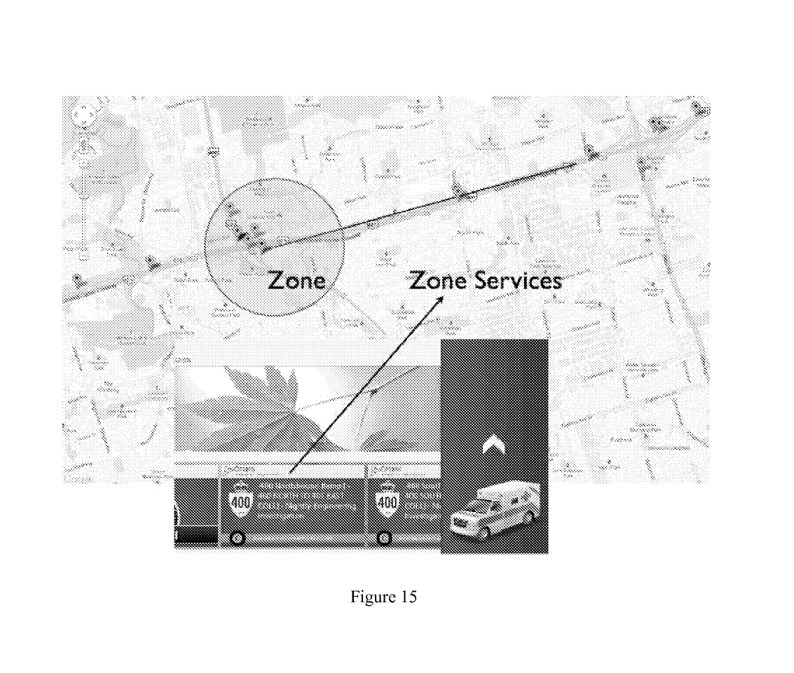

It is also contemplated that a zone can be instantiated within a zone server operating within a mobile device. Consider a social gathering or a gaming environment where a zone can be instantiated on a cell phone allowing nearby cell phones to participate with the zone. Suitable techniques that can be adapted to construct such zones are disclosed in the Applicant's own work as discussed U.S. patent application publication 2011/0125850 to Rahnama et al. titled “Method, Apparatus and System for Social Networking”, filed as an international application on Mar. 11, 2008. Still, further the zone can be instantiated so that is bound to a moving vehicle, an ambulance for example. The instantiated zone can be deployed within the moving vehicle, or instantiated on a remote zone server that tracks movement of the vehicle as illustrated in FIG. 15. Thus, zone can be considered a dynamic or time varying object. For example, an emergency vehicle represented as a zone, can alert proximate vehicles, other zones, or zone services on its location and speed.

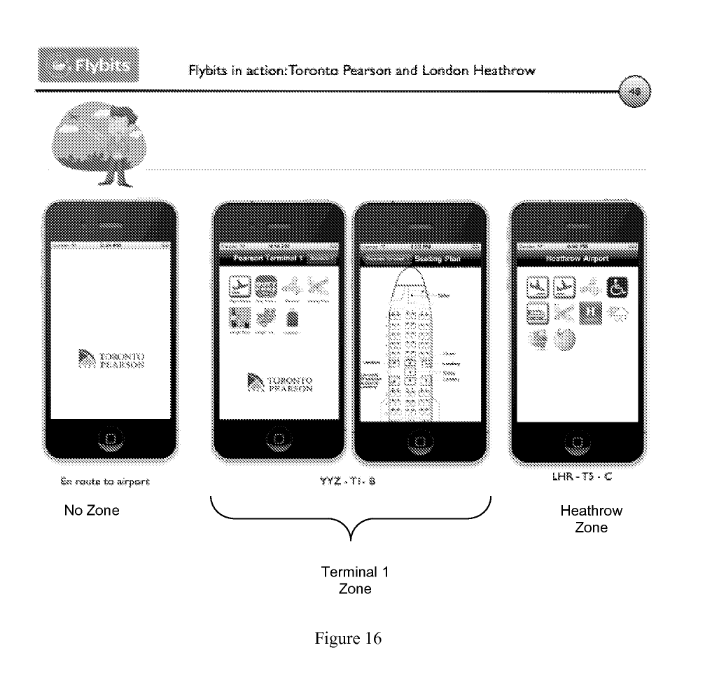

The method can further include configuring one or more electronic devices to be receptive to the zone application upon detecting that the electronic device is contextually relevant the zone. When device attributes indicate that the electronic device falls within the context of the zone, a zone server or other suitable entity can activate the zone's services or applications on the electronic device. In some embodiments, the electronic device can be provisioned within one or more service-type handlers in a thin client, or similar operating system handler modules. The handlers can be activated so they become receptive to the zone upon becoming contextually relevant. When activated, corresponding icons or other indicators can be presented to the user to indicate the presence of corresponding services. Similarly, when the device falls outside a contextual boundary of the zone, the service-type handlers can be deactivated or removed from presentation so that they are no longer available to the user. Consider the use-case in FIG. 16, which illustrates a flight passenger's experience with their cell phone as the user moves from zone to zone in and around airports during their trip. At the far left, the passenger has not yet entered a zone. Upon entering the “Terminal 1 Zone” at their departing airport, the passenger's cell phone populates with available services: flight status, duty free shop, terminal map, seating plan, in-flight mall, in-flight entertainment, luggage, or other services. The passenger can launch the seating plan service to view where their seat is on their flight. As the passenger leaves the “Terminal 1 Zone” on their flight, the service indicators depopulate. When the passenger arrives at their destination and enters the “Heathrow Zone”, their cell phone again automatically populates with services specific to the “Heathrow Zone”.

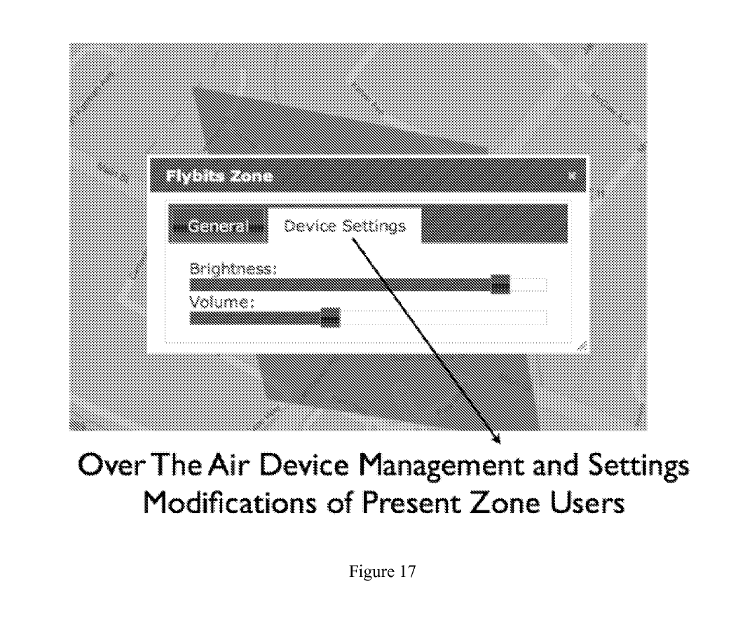

Activating the service-type handlers can also include provisioning the electronic device with a platform-specific service type handler. For example, the platform-specific service-type handler could include downloading or launching a native application on the device. Further, the platform-specific service-type can be provisioned from a device management engine, which monitors the electronic device attributes and provides native features to the electronic device. FIG. 17 illustrates modifying a zone object so that electronic devices take on specific configurations when entering the zone. In the example show, electronic devices will have their screen brightness and volume adjusted. Such an approach might be advantageous in a movie theater where a cell phone volume should be low or the device should be turned off. In this example, the theatre is considered a zone and users will connect to the zone for receiving relevant services. The ontology and the rule base that is governing the theatre zone will change the device settings of the phone and ensures that the phones are switched to vibration mode. Same is applicable to government and classified buildings in which camera-based interfaces should be turned off when users are detected in their Zones. Zone-based configuration of an electronic device can include adjusting sensor settings, turning device features on or off, adjusting or configuring applications, acquiring device data, allocating computing resources, storing data, or other functions.

Contemplated methods can also include generating zone analytics. As the zone continues its existence, the zone server can compile the history of the zone or behaviors of zone participants. The zone server, or other analysis engine, can analyze the data for various purposes. For example, the demographics of participants can be compiled and sold to advertisers, thus increasing the intrinsic value of the zone. Further, the zone analytics can give an indication of a zone rating where the rating indicates how well participant receives or likes the zone's offerings.

The method can also include providing access to the zone database to allow users to search for interesting zones. For example, when a user submits a query to a public search engine, the search engine can search for zone objects have properties satisfying the query. Consider an example where a user wishes to search for local restaurants offering a particular type of cuisine. The search engine can return zones offering services allowing the user to make reservations at a restaurant offering the specified cuisine.

### Additional Considerations

The inventive subject discussed above provides a platform on which entitles can construct zone applications, which provide intelligent data, functionally, or other services to zone participants. In view that the subject matter comprises an extensive infrastructure, there are broad spectrums of capabilities that can be built on the infrastructure. The following discussion outlines capabilities, features, or other aspects of the technology that are considered to fall within the scope of the inventive subject matter.

Zones are considered distinct manageable objects that can have a dynamic existence and whose existence can be considered an application. Each zone can offer a wide variety of application capabilities including entertainment, gaming, social networking, productivity, computation, or other types of services. In view that zones can function as an application, one should appreciate that zones can also cooperate with each other to give rise to more complex or even emergent behaviors. Zones can cooperate through zone-to-zone communication techniques including migrating services from one zone to another, announcing presence of a zone, discovering zones, sending data from one zone to another via a user's electronic device, generating Service Level Agreements (SLA), zone-to-zone APIs via corresponding zone servers, or other communication systems. In some embodiments a zone can also be assigned an IP address, an identifier, a URL, or other type of address to allow the zone to communicate with each other or with other networked entities.

As an example consider a computational zone where the zone has been constructed to allocate computing resources of participating electronic devices. The zone, assuming proper authentication or authorization, can allocate CPU power or memory of the electronic devices and have the devices execute instructions. Examples users could include scientific modeling or analysis (e.g., cryptographic key analysis, protein folding, etc.), image rendering, AI applications, gaming, or other computation projects.

The dynamic nature of zones can depend on a number of factors. Zones can be constructed as ad hoc zones based on triggering conditions. For example, when a number of individuals falling within to a key demographic enter a building, a zone can be instantiated to provide desire services as a function of the number of present participants or other factors. Further, electronic devices in proximity to each other can auto construct an ad hoc zone. Still further, zones can be constructed to depend on time where the zone moves with time, changes shape with time, shifts services with time, or other aspects. Consider a highway department that seeks information about a highway during rush hour. A zone can be constructed that covers a portion of the highway and then sweeps along a length of the highway. As the zone moves, the zone can collect vehicular information or statistics from devices or vehicles in the current zone window where the vehicular information can be used for safety notifications or other purposes.

Zones preferably function according to one or more rules sets defining a context for the zone. The rules sets can be simple rules governing zone boundary enforcement, geographical boundaries for example, or the rules can be quite complex. Complex rules can govern the behavior of one or more zone inference engines that monitor or analyze data associated with the zone. More specifically, the rules can operate as a function of the attribute space of the zone, possibly based on location-based algorithm to deliver location-based services. Users in the zone can participate with the service based on their GPS location, triangulation location, marker based locations, or other locations.

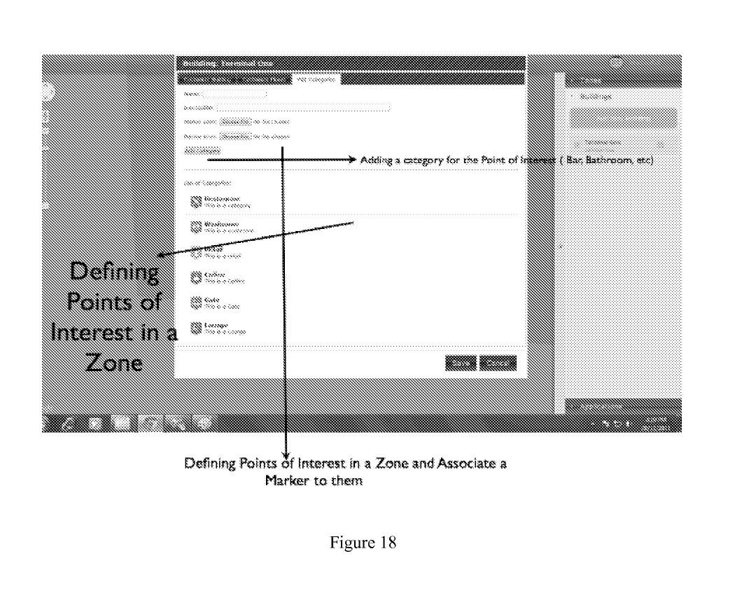

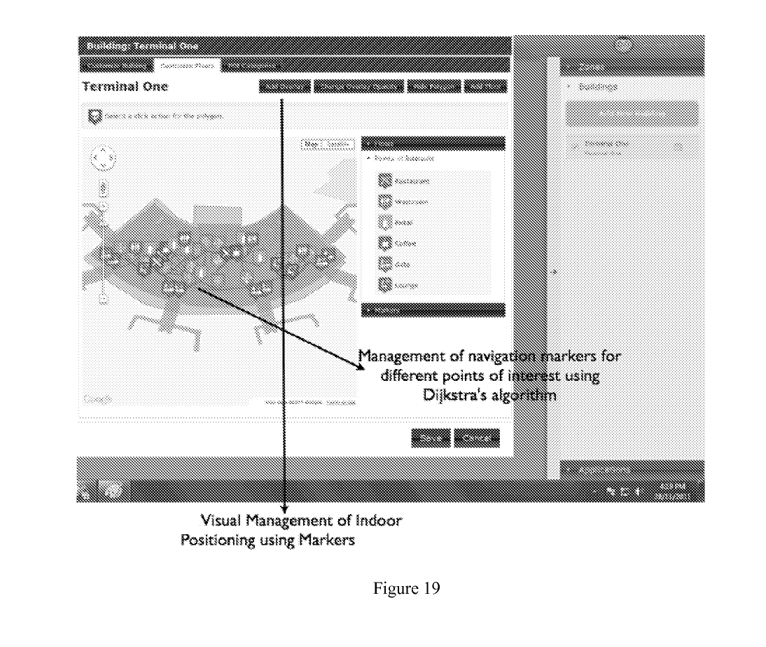

Consider a set of rules that govern zone behavior based on displayed markers. As discussed previously, a zone manager can identify numerous points-of-interest (POI) within a zone as illustrated in FIG. 18. The zone management system can automatically generate a unique marker for each POI in the zone. The marker can also be a shape, image or pattern that can reference information on a network or on a local device. One should appreciate that the marker needs only be unique for a zone so that the same marker can be used in other zones without collision. The markers can be manufactured and placed at the each POI as desired. Then users can be routed from one POI to another based on the zone context or the user's context as indicated in FIG. 19, which illustrates an airport terminal zone that has been instrumented with zone markers. FIG. 20A illustrates an example of a proprietary zone maker developed by the Applicant. FIG. 20B illustrates how a single marker in a zone can change its apparent behavior based on a device context. The top image illustrates an overlay message giving directions to a gate for a departing passenger while the bottom image illustrates an overlay message giving directions to baggage claim for an arriving passenger.

Zones have intrinsic value based on their context, boundaries, services, or other factors. Based on their value, the zones or zone objects can be bought, sold, traded, or exchanged among zone owners. Further, zone participants can purchase access to zones. In some embodiments, an airport for example, some zone services might be provided for free. While in other embodiments, zones might offer for-fee services where zone participants must pay the zone owner a fee to access the zone or some of its services. Consider a zone operating as a gaming environment. Game players can pay a subscription, or other fee, to the zone owner in exchange for participating in the zone. Thus, one aspect of the infrastructure is considered to include account management, especially transaction or financial account management, among zone owners or zone participants.

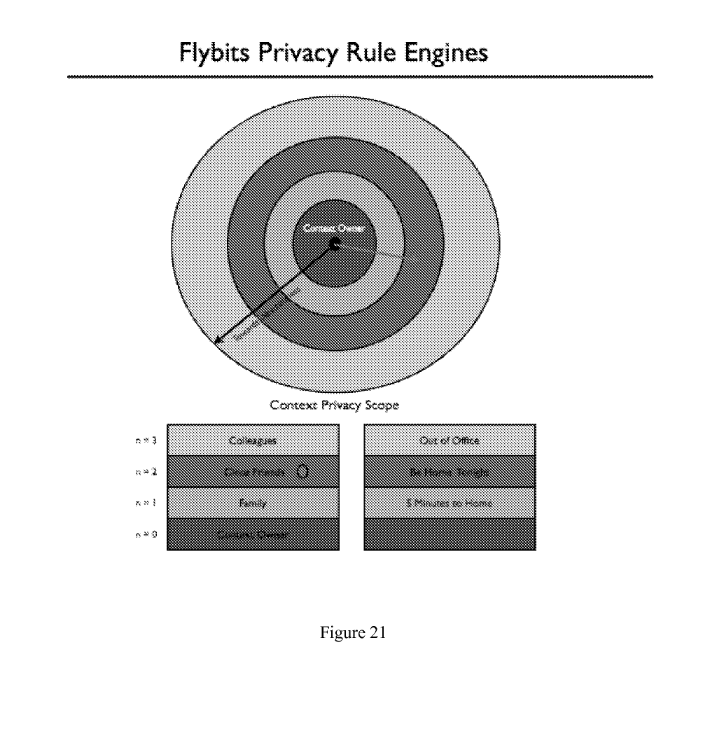

Further, zone access can be governed by permissions or access levels assuming proper authentication or authorization. Zone access can be governed by one or more privacy rules engines or access levels. Access levels of a zone can be customized as desired. In more preferred embodiments a zone template can provide an a priori defined or default set of access levels. For example, a zone or its services can be labeled as private, protected, or public. If an electronic device satisfies the requirements or optional conditions of a level, then the device participates with the zone at the level. Further, interactions among zone participants or zone services can be governed by privacy rules as illustrated in FIG. 21. Depending on a current relationship in the zone between participants, their privacy can be enforced. For example, when an employee is leaving an office zone after a day of work, colleagues are notified that the employee is out of the office while close friends are informed that the employee will be home soon.

Zones can also offer many different forms of security. Preferred zone management systems comply with Privacy By Design (see URL privacybydesign.ca) or are Identity Credential Access Management (ICAM) compliant (see URL www.idmanagement.gov/pages.cfm/page/IDManagement-Identity-Credential-and-Access-Management). Further, zone access can be locked, unlocked, hidden, or found based on recognizing user behavior associated with a zone. For example, the zone can detect movement of the user's electronic device and when the electronic device hits several waypoints in the zone, the zone become unhidden and its services can be presented to the user. A current implementation by FLYBITS comprises an activity recognition engine, call Flybits Activity Recognition Engine (FARE). FARE can be adapted for use to detect patterns in user, device, or zone behaviors.

Electronic devices can move from zone to zone. In such scenarios, zone's can employ one or more hand-off algorithms designed to hand-off an electronic device from one zone to another zone assuming a hand-off is required. Such an approach is useful when multiple zones overlap or neighbor each other but offer differing services. For example, in an airport a terminal or gate zone might hand off a passenger's electronic device to a duty-free shop zone when the passenger goes shopping, thus giving the shop zone higher precedence over the terminal zone. Should the terminal zone send an urgent notification (e.g., “Your Flight is Leaving”), the notification can interrupt the shop zone services and present the notification.

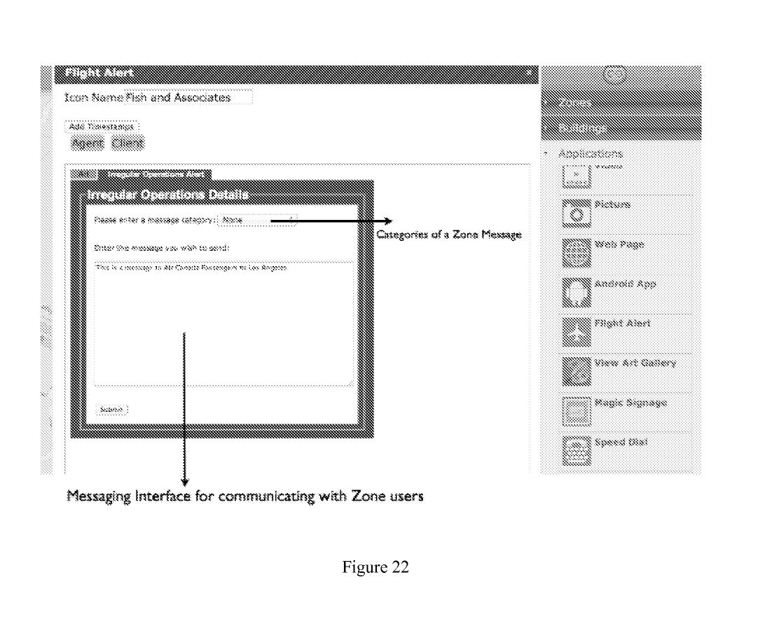

Zones can also be used to providing real-time information to participants as desired. The information can be supplied by the zone automatically or could be provided by a zone manager. FIG. 22 illustrates a messaging component that can be used to send messages to zone participants. The zone manager enters the message and submits the message to the zone server. In response, subject to access level or other requirements, the zone server pushes the message to all the participants.

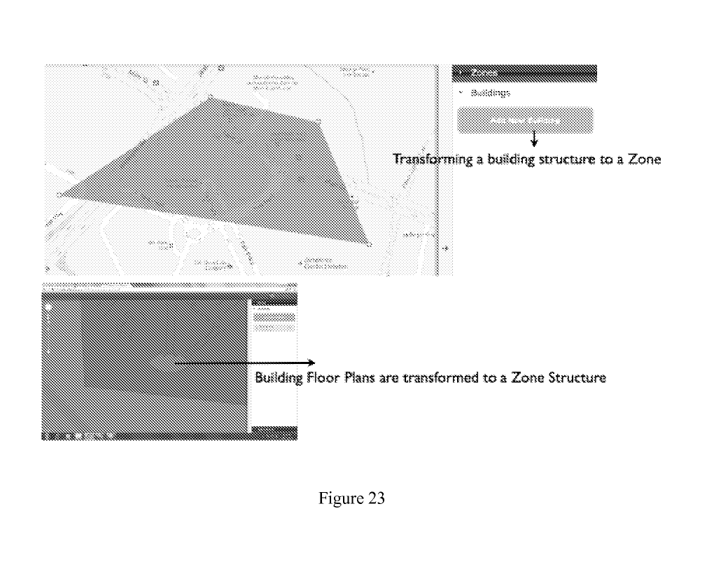

Zones can be automatically created based on information obtained from a zone manager as illustrated with FIG. 23. For example, a zone manager can submit an office floor plan (e.g., a CAD drawing) and address to a zone management system. In response, the zone management server can establish boundaries around the floor plan and based the geographic location of the address. Further, the zone management server can offer one or more recommendations on services for the zone as a function of the information available. If the address happens to be located near one or more restaurants, the management server could recommend providing an advertisement plug-in allowing local restaurant owners to advertise to users associated with the zone.

In some embodiments, a zone owner might own thousands of zones, all of which require management or synchronization. For example, a retail chain store might have thousands of locations world wide. The retail chain can possibly organize their zones in a hierarchal fashion for easy reference or retrieval. Further, the chain can establish a service or other property of the zone and cause the zone management server to synchronize all zones to have the same service. Additionally, the chain could create a single zone, then replicate the zone, or at least portions of the zone properties, to create additional zones for each store location. Naturally, geographic boundaries of the zones would likely vary while other aspects of the zone criteria might not; user roles, plug-ins, or services for example.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A zone management system comprising:
a zone database configured to store zone objects owned by different zone owners, each
zone object representative of a zone and having:
zone context criteria defined according to zone attributes adhering to an attribute space, and
at least one zone service;
a device interface configured to communicatively coupled with an electronic device; and
a zone server coupled with the zone database and the device interface, and configured to:
allow a zone owner to instantiate a zone object as an instantiated zone from the zone database by activating the at least one service as a persistent service according the zone object's context criteria;
obtain device attributes from the electronic device via the device interface;
derive a device context from the device attributes;
identify the persistent service as being contextually relevant to the device context by comparing the device attributes to the zone object's zone context criteria; and
configure the electronic device to participate with the persistent service according the device context and the zone context criteria.

2. The system of claim 1, further comprising a zone management interface coupled with the zone database and configured to offer a plurality of zone management functions to the zone owners.

3. The system of claim 2, wherein the zone management interface comprise a geographical zone definition tool.

4. The system of claim 3, wherein the geographical zone definition tool comprise at least one the following: a map, a floor plan, a topology, a political boundary, an overlay, a street, a restricted air space, an air space, an area, a volume, and an object.

5. The system of claim 2, wherein the zone server is further configured to configure substantially in real-time the electronic device to participate with the at least one service according to an updated zone criteria submitted via the zone management interface.

6. The system of claim 1, wherein the attribute space comprises at least one following types of attributes: geo-location, time, position, orientation, identity, weather, temperature, pressure, motion, demographics, value, density, rights, regulations, relationships, resources, and news events.

7. The system of claim 1, wherein the zone context criteria comprises a zone context defined as a function of the attribute space.

8. The system of claim 7, wherein the zone object comprises a pointer to a zone context plug-in.

9. The system of claim 8, wherein the zone context plug-in comprise at least one of the following: zone context sensor plug-in, zone inference engine plug-in, zone roles plug-in and zone rules plug-in

10. The system of claim 7, wherein the zone context comprises an a priori defined context.

11. The system of claim 1, wherein zone context criteria comprise a zone profile template.

12. The system of claim 11, wherein the zone server is further configured to instantiate the zone object by populating features of the zone profile template.

13. The system of claim 11, wherein the zone profile template comprises at least one of the following types of templates: an airport template, a public transit template, a conference template, a social networking template, an office template, a dinning template, and a gaming template.

14. The system of claim 1, wherein the zone server is further configured to activate a service-type handler on the electronic device to be receptive to the persistent service.

15. The system of claim 14, wherein the zone server is further configured to provision a platform-specific handler as the service type handler on the electronic device to be receptive to the persistent service.

16. The system of claim 15, further comprising a device management engine coupled with the zone server, and configured to deliver the platform-specific handler.

17. The system of claim 1, wherein the persistent service comprises a zone-bounded service.

18. The system of claim 1, wherein the persistent service comprises a navigation service.

19. The system of claim 30, wherein the navigation service configures the electronic device to be receptive to contextual zone markers deployed within a geographical boundary of the zone.

20. The system of claim 1, wherein the zone server is configured to restrict access to zone objects to zone owners according to zone owner authentication.
